(19) United States
(12) Patent Application Publication
(10) Pub. No.: US 2023/0412979 A1
(43) Pub. Date: Dec. 21, 2023

(54) Sound Reproducing Apparatus And Method

(71) Applicant: Sony Group Corporation, Tokyo (JP)

(72) Inventors: Hiroshi Yoshioka, Kanagawa (JP); Shigeo Gomyo, Kanagawa (JP); Takumi Miyakawa, Tokyo (JP); Hiroyuki Shirakawa, Kanagawa (JP); Takahisa Tagami, Kanagawa (JP)

(73) Assignee: Sony Group Corporation, Tokyo (JP)

(21) Appl. No.: 18/029,226

(22) PCT Filed: Sep. 24, 2021
(86) PCT No.: PCT/JP2021/034949

§ 371 Date: Mar. 29, 2023

(30) Foreign Application Priority Data
Oct. 6, 2020 (JP) 2020-169321

(51) Int. Cl. H04R 3/14; H04R 1/34; H04R 1/26; H04R 3/04

(52) U.S. Cl. CPC H04R 3/14; H04R 1/345; H04R 1/26; H04R 3/04

(57) ABSTRACT

The present technology relates to a sound reproducing apparatus and a sound reproducing method capable of realizing appropriate sound image localization without deteriorating sound quality.

The sound reproducing apparatus includes a reflection speaker that is capable of performing directivity control and outputs a sound toward a predetermined surface on the basis of a high-band signal of a sound signal, and a plurality of low-band speakers that is disposed near the predetermined surface and each outputs a sound on the basis of a low-band signal of the sound signal. The present technology is applicable to a sound reproducing apparatus.

### TECHNICAL FIELD

The present technology relates to a sound reproducing apparatus and a sound reproducing method, and particularly to a sound reproducing apparatus and a sound reproducing method capable of realizing appropriate sound image localization without deteriorating sound quality.

### BACKGROUND ART

For example, if localization of a sound image is achievable at a predetermined position, such as a position of a person within a screen of a display, in a case of reproduction of content including pictures and voices with use of a large-sized display or the like, such as a television set, a sense of realism offered by the content can improve.

Accordingly, there has been proposed such a technology which arranges speakers at upper and lower ends of the display, for example, and performs panning, which is a process for adjusting a sound image position through adjustment of relative sound volumes of these speakers, for example, to localize a sound image within a display screen.

Technologies also proposed include a technology which arranges a speaker array at an end of a display and localizes a sound image within a screen by using this speaker array (e.g., see PTL 1), and a technology which arranges a speaker array called a sound bar behind a listener (e.g., see PTL 2).

There has been further proposed such a technology which causes a sound emitted from a speaker toward a display screen to reflect on the screen to localize a sound image within the display screen.

### CITATION LIST

### Patent Literature

### [PTL 1]

Japanese Patent Laid-open No. 2012-235426

### [PTL 2]

PCT Patent Publication No. 2020/144937

### SUMMARY

### Technical Problems

According to the technologies mentioned above, however, appropriate sound image localization without deterioration of sound quality is difficult to realize.

For example, according to the technology which realizes sound image localization by panning, sound emission positions are easily identified by a listener if speakers each constituting a point sound source are used. Particularly, sounds at a high frequency are felt as if they are directly coming from the positions of the speakers. Moreover, in a case of this technology, a sound image is localized at the position of the speaker closer to the listener if the height of the listener in the up-down direction varies with respect to an ideal listening position.

Furthermore, according to the technology which causes sound reflection on the display screen, for example, low-band reproduction is difficult to achieve by using only reflection sounds from the display screen. Accordingly, sound quality may be deteriorated.

The present technology has been developed in consideration of the abovementioned circumstances, and can realize appropriate sound image localization without deteriorating sound quality.

### Solution to Problems

A sound reproducing apparatus according to one aspect of the present technology includes a reflection speaker that is able to perform directivity control and outputs a sound toward a predetermined surface on the basis of a high-band signal of a sound signal, and a plurality of low-band speakers that is disposed near the predetermined surface and each outputs a sound on the basis of a low-band signal of the sound signal.

A sound reproducing method according to one aspect of the present technology is a method for a sound reproducing apparatus that includes a reflection speaker that is able to perform directivity control, and a plurality of low-band speakers disposed near a predetermined surface. The sound reproducing method includes outputting a sound toward the predetermined surface on the basis of a high-band signal of a sound signal by using the reflection speaker and outputting a sound on the basis of a low-band signal of the sound signal by using the plurality of low-band speakers.

According to the one aspect of the present technology, the sound reproducing apparatus that includes a reflection speaker capable of performing directivity control and a plurality of low-band speakers disposed near a predetermined surface outputs a sound toward the predetermined surface on the basis of a high-band signal of a sound signal by using the reflection speaker, and outputs a sound on the basis of a low-band signal of the sound signal by using the plurality of low-band speakers.

### BRIEF DESCRIPTION OF DRAWINGS

FIG. 1 is a diagram explaining reproduction of content and sound image localization.

FIG. 2 is a diagram depicting a configuration example of a sound reproducing apparatus.

FIG. 3 is a diagram depicting an arrangement example of a reflection speaker and low-band speakers.

FIG. 4 is a diagram depicting an example of reproduction bands of the reflection speaker and the low-band speakers.

FIG. 5 is a diagram depicting an arrangement example of the reflection speaker and the low-band speakers.

FIG. 6 is a diagram explaining directivity control by the low-band speakers.

FIG. 7 is a diagram explaining a precedence sound effect of the reflection speaker.

FIG. 8 is a flowchart explaining a reproduction process.

FIG. 9 is a diagram depicting an arrangement example of reflection speakers and the low-band speakers.

FIG. 10 is a diagram explaining a shift of a sound image by the reflection speaker.

FIG. 11 is a diagram depicting an example of the reflection speaker.

FIG. 12 is a diagram depicting an example of directivity control by the reflection speaker.

FIG. 13 is a diagram depicting an example of the reflection speaker.

FIG. 14 is a diagram depicting an arrangement example of the reflection speakers and the low-band speakers.

FIG. 15 is a diagram depicting an example of reproduction bands of the reflection speakers and the low-band speakers.

FIG. 16 is a diagram depicting a configuration example of the sound reproducing apparatus.

FIG. 17 is a diagram depicting an arrangement example of the reflection speakers and the low-band speakers.

FIG. 18 is a diagram depicting an arrangement example of the reflection speakers.

FIG. 19 is a diagram explaining interference and sound pressure in respective regions.

FIG. 20 is a diagram depicting a sound simulation result.

FIG. 21 is a diagram depicting a configuration example of a computer.

### DESCRIPTION OF EMBODIMENT

An embodiment to which the present technology is applied will be hereinafter described with reference to the drawings.

### First Embodiment

### <Present Technology>

The present technology reproduces high-band components by using a reflection speaker which causes reflection of sounds on a display surface such as a display, and also reproduces low-band components by using a plurality of low-band speakers provided adjacent to the display surface and achieving panning to realize appropriate sound image localization without deteriorating sound quality.

For example, suppose that content including pictures and voices accompanying the pictures is reproduced.

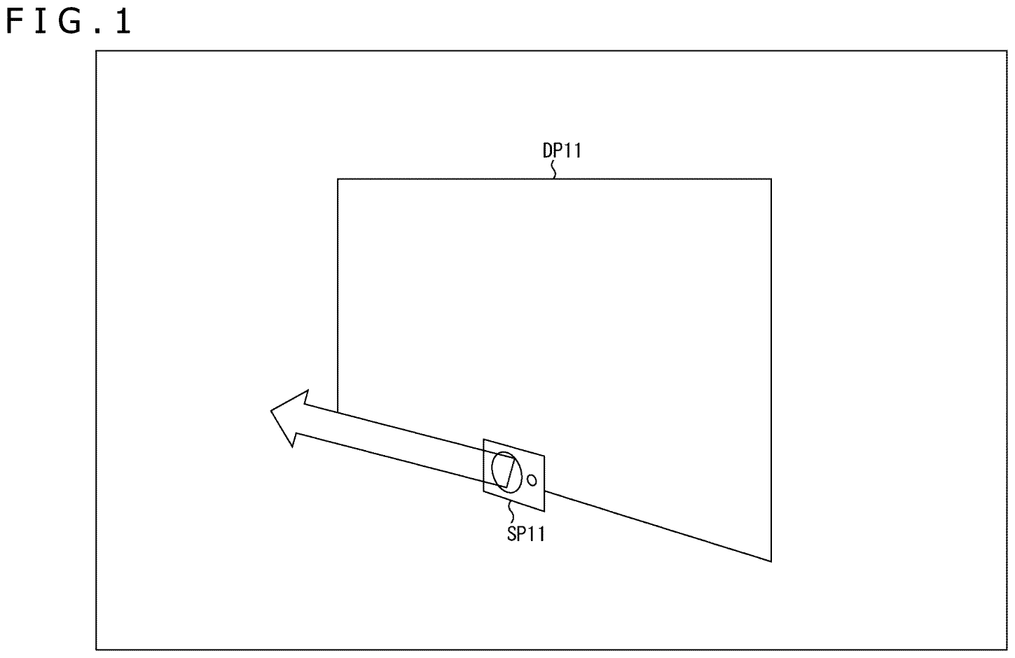

Specifically, it is assumed that pictures are reproduced using a display DP 11 and that sounds from C-channel (center channel) or the like are reproduced using a speaker SP 11 as depicted in FIG. 1. Moreover, it is assumed that a listener is located in front of the display DP 11.

In this example, the speaker SP 11 constituting a point sound source is disposed adjacent to a center of a lower end of the display DP 11 so as not to block a display screen of the display DP 11.

Accordingly, when a sound is reproduced by the speaker SP 11, the listener hears this sound from a lower part of the display DP 11. In this case, a sound image is not localized within the screen of the display DP 11, and therefore the content is difficult to reproduce with a high sense of realism. This deviation between a desired sound image position and an actual sound image position (sound emission position) increases as the size of the display DP 11 increases.

It is therefore considered to arrange speakers each constituting a point sound source at left and right ends or upper and lower ends of the display DP 11 and perform panning, which is a process for adjusting a sound image position through adjustment of relative sound volumes of these speakers, for example, to localize a sound image within the display screen of the display DP 11.

However, in a case where the speakers are arranged at the left and right ends of the display DP 11, a sound image is localized at the position of the speaker closer to the listener when the listening position deviates toward the left or the right from the position right in front (center) of the display DP 11.

Meanwhile, in a case where the speakers are arranged at the upper and lower ends of the display DP 11, localization of a sound image at either one of the speaker positions is avoidable even when the listening position deviates toward the left or the right. However, in a case of deviation of the listening position in the up-down direction, a sound image is localized at the position of the speaker closer to the listener.

Moreover, the sound emission positions of the speakers each constituting a point sound source are easily identified by the listener. Particularly, sounds at a high frequency are directly heard from the positions of the speakers. Accordingly, a sound image cannot be localized at a desired position in some cases.

Furthermore, a sound emission position of a line sound source is more difficult to recognize by the listener than that of a point sound source. Accordingly, it is also considered to use an array speaker including a plurality of speakers (speaker units) rather than a speaker constituting a point sound source.

Specifically, it is considered to arrange array speakers at the upper and lower ends of the display DP 11 and localize a sound image within the screen of the display DP 11 by panning, for example.

This case achieves some improvement from the case using a speaker constituting a point sound source. However, a sound image is still localized at the position of the array speaker closer to the listener if the listening position deviates in the up-down direction. In addition, sounds at a high frequency are directly heard from the positions of the array speakers.

Besides, it is also considered to adopt a method which localizes a sound image within the screen of the display DP 11 by causing sounds to reflect within the screen with use of a reflection speaker. However, low-band reproduction is difficult to achieve using only reflection sounds from the screen of the display DP 11, and sound quality may be deteriorated.

Accordingly, the present technology reproduces high-band components of sounds of content by using a reflection speaker, and reproduces low-band components of sounds of content by panning achieved by a plurality of low-band speakers to realize appropriate sound image localization without deteriorating sound quality.

In such a manner, a sound image can be localized within a display surface where pictures are displayed, such as a display, with use of a reflection speaker, and sound quality deterioration can be prevented by reproducing, with use of low-band speakers, a low band where sound pressure produced by a reflection speaker is insufficient or where reproduction is difficult to achieve by a reflection speaker.

### Configuration Example of Sound Reproducing Apparatus

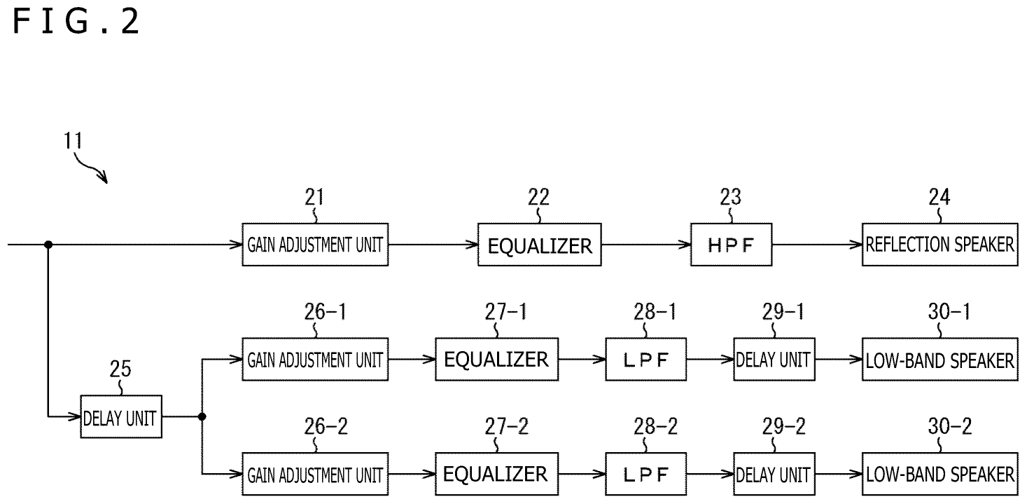

FIG. 2 is a diagram depicting a configuration example of a sound reproducing apparatus to which the present technology is applied according to one embodiment.

A sound reproducing apparatus 11 depicted in FIG. 2 includes a gain adjustment unit 21, an equalizer 22, an HPF (High Pass Filter) 23, a reflection speaker 24, a delay unit 25, a gain adjustment unit 26-1, a gain adjustment unit 26-2, an equalizer 27-1, an equalizer 27-2, an LPF (Low Pass Filter) 28-1, an LPF 28-2, a delay unit 29-1, a delay unit 29-2, a low-band speaker 30-1, and a low-band speaker 30-2.

A sound signal for reproducing a sound of content is supplied to each of the gain adjustment unit 21 and the delay unit 25 of the sound reproducing apparatus 11. For example, the content herein includes pictures, and sounds (voices) accompanying the pictures.

The gain adjustment unit 21 makes gain adjustment for the supplied sound signal and supplies the sound signal after gain adjustment to the equalizer 22.

For example, the gain adjustment unit 21 makes gain adjustment for the sound signal so as to equalize the sum of sound pressures of sounds output from the low-band speaker 30-1 and from the low-band speaker 30-2 with a sound pressure of a sound output from the reflection speaker 24.

The equalizer 22 performs an equalizer process for the sound signal supplied from the gain adjustment unit 21 to adjust frequency characteristics of the sound signal and supplies a sound signal obtained by this process to the HPF 23.

For example, the equalizer 22 performs such an equalizer process which enables sounds output from the reflection speaker 24 to obtain desired frequency characteristics such as flat frequency characteristics.

The HPF 23 filters the sound signal supplied from the equalizer 22 to allow only high-band components of the sound signal to pass and supplies a high-band signal obtained by this filtering to the reflection speaker 24. In other words, the HPF 23 functions as a high-band filter unit which generates a high-band signal on the basis of the sound signal.

Note that the HPF 23 may be implemented by the equalizer 22.

The reflection speaker 24 outputs, on the basis of the high-band signal supplied from the HPF 23, sounds (sound waves) toward a desired position on a display surface where the pictures of the content are displayed to reproduce high-band components of sounds of the content.

The reflection speaker 24 is capable of controlling directivity of output sounds and includes a speaker designating a high band as a band to reproduce. For example, the reflection speaker 24 is an array tweeter, a horn tweeter, a beam tweeter, a flat speaker, or the like.

For example, the array tweeter is an array speaker (speaker array) produced by arranging a plurality of high-band speakers (speaker units) called tweeters on a two-dimensional plane or the like. The horn tweeter is a horn speaker (horn-type speaker) including one high-band speaker unit having narrow directivity characteristics defined by a horn.

The beam tweeter is an array speaker produced by linearly arranging a plurality of tweeters, i.e., a plurality of high-band speakers (speaker units), for example, and is capable of outputting sounds in a desired direction. In addition, the flat speaker is a speaker having a flat-plate-shaped diaphragm and also called a flat panel speaker or the like.

The delay unit 25 delays the supplied sound signal by a predetermined time, and then supplies the delayed sound signal to each of the gain adjustment unit 26-1 and the gain adjustment unit 26-2.

For example, the delay unit 25 performs a process for delaying the sound signal such that the sound output from the reflection speaker 24 reaches the listener earlier than the sounds output from the low-band speaker 30-1 and the low-band speaker 30-2. This process is performed so as to obtain a precedence sound effect described below.

The gain adjustment unit 26-1 and the gain adjustment unit 26-2 each make gain adjustment for the sound signal supplied from the delay unit 25 and supply the sound signal after gain adjustment to the equalizer 27-1 and the equalizer 27-2, respectively.

For example, each of the gain adjustment unit 26-1 and the gain adjustment unit 26-2 makes gain adjustment for the sound signal so as to obtain desired sound pressure, i.e., equalize a sound pressure of a sound output from the low-band speaker 30-1 with a sound pressure of a sound output from the low-band speaker 30-2, for example.

Note that each of the gain adjustment unit 26-1 and the gain adjustment unit 26-2 will be simply referred to as a gain adjustment unit 26 hereinbelow in a case where no particular distinction between these units is needed.

The equalizer 27-1 and the equalizer 27-2 each perform an equalizer process for the sound signal supplied from the gain adjustment unit 26-1 and the gain adjustment unit 26-2, respectively, and supply a sound signal obtained by this process to the LPF 28-1 and the LPF 28-2, respectively.

For example, as in the case of the equalizer 22, the equalizer 27-1 and the equalizer 27-2 also perform an equalizer process so that the sound output from the low-band speaker 30-1 and the low-band speaker 30-2, respectively, obtains desired frequency characteristics such as flat frequency characteristics.

Note that each of the equalizer 27-1 and the equalizer 27-2 will be also simply referred to as an equalizer 27 hereinbelow in a case where no particular distinction between these equalizers is needed.

The LPF 28-1 and the LPF 28-2 each filter the sound signal supplied from the equalizer 27-1 and the equalizer 27-2, respectively, to allow only low-band components of the sound signal to pass, and supply a low-band signal obtained by this filtering to the delay unit 29-1 and the delay unit 29-2, respectively.

Note that each of the LPF 28-1 and the LPF 28-2 will be also simply referred to as an LPF 28 hereinbelow in a case where no particular distinction between these LPFs is needed. Each of the LPFs 28 functions as a low-band filter unit which generates a low-band signal on the basis of the sound signal. Each of the LPFs 28 may be implemented by the equalizer 27.

The delay unit 29-1 and the delay unit 29-2 each delay the low-band signal supplied from the LPF 28-1 and the LPF 28-2, respectively, by a predetermined time, and then supply the delayed low-band signal to the low-band speaker 30-1 and the low-band speaker 30-2, respectively.

For example, the delay unit 29-1 and the delay unit 29-2 each perform a process for delaying the low-band signal so as to make appropriate adjustment of arrival time of the sound at the listener, such as adjustment in which the sound output from the low-band speaker 30-1 and the sound output from the low-band speaker 30-2 are simultaneously arrived at the listener.

Note that each of the delay unit 29-1 and the delay unit 29-2 will be also simply referred to as a delay unit 29 hereinbelow in a case where no particular distinction between these units is needed.

Moreover, the delay process performed by the delay unit 25 for delays of the sounds emitted from the low-band speaker 30-1 and the low-band speaker 30-2, which are relative delays from the sound emitted from the reflection speaker 24, may be performed by the delay units 29. In this case, the necessity of providing the delay units 25 is eliminated.

The low-band speaker 30-1 and the low-band speaker 30-2 each output a sound on the basis of the low-band signal supplied from the delay unit 29-1 and the delay unit 29-2, respectively, to reproduce low-band components of sounds of content.

Note that each of the low-band speaker 30-1 and the low-band speaker 30-2 will be also simply referred to as a low-band speaker 30 hereinbelow in a case where no particular distinction between these speakers is needed.

Each of the low-band speakers 30 may be any speaker as long as a low band is designated as a band to reproduce, such as an array speaker produced by arranging a plurality of low-band speakers, and a speaker including a single speaker unit constituting a point sound source.

For example, in a case where an array speaker is adopted as each of the low-band speakers 30, directivity control is achievable by the low-band speakers 30.

### Example of Speaker Arrangement

An arrangement example of the reflection speaker 24 and the low-band speakers 30 will be described herein.

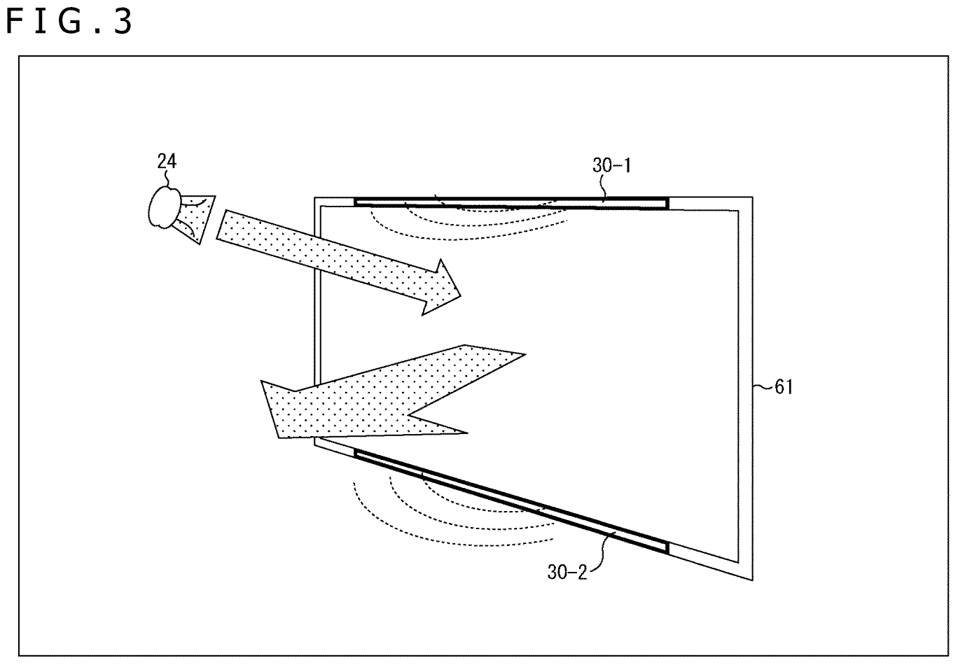

For example, in a case where the reflection speaker 24 and the low-band speakers 30 are used as a horn tweeter and array speakers, respectively, an arrangement depicted in FIG. 3 by way of example may be adopted for these speakers.

In the example depicted in FIG. 3, pictures of content are reproduced by a display 61, while sounds of content are reproduced by the reflection speaker 24 and the low-band speakers 30. Note that the display 61 may be included in the sound reproducing apparatus 11 or may be provided separately from the sound reproducing apparatus 11.

In FIG. 3, the low-band speakers 30 are disposed in the vicinity of a display screen of the display 61. Specifically, the low-band speaker 30-1 is disposed adjacent to an upper end (an upper end in the vertical direction) of the display 61, while the low-band speaker 30-2 is disposed at the lower end of the display 61. In addition, the reflection speaker 24 is disposed in an upper part of the front of the display 61.

The reflection speaker 24 herein is a horn tweeter, and sounds having directivity characteristics defined by a shape of a horn forming this horn tweeter are output from the reflection speaker 24. In other words, directivity of sounds output from the reflection speaker 24 is controlled by the horn shape.

The reflection speaker 24 is fixed to a ceiling or the like inside a room in such a state as to face the display 61 beforehand to cause a sound output from the reflection speaker 24 to reflect at a desired position on the display 61 and reach the listener. The reflection speaker 24 is capable of controlling directivity, i.e., has pointed directivity (directivity characteristics), and therefore achieves emission of sounds toward only a partial region of the screen of the display 61.

In this case, the listener listens to a reflection sound output from the reflection speaker 24 and reflected on the display 61. Accordingly, the listener perceives a sound based on a high-band signal, i.e., a sound of content as if this sound is localized at a position (reflection position) on the screen of the display 61.

Moreover, in this example, realization of appropriate sound image localization and content reproduction offering a sense of realism can be easily achieved by reflecting high-pitched sounds (high-band components) which exhibit particularly clear localization, i.e., which are effective in localization, on the display 61, and localizing a sound image at a desired position within the screen of the display 61.

Meanwhile, low-band components have characteristics of unclear localization (low sense of localization) in comparison with high-band components.

In a case of the sound reproducing apparatus 11, low-band components of content are reproduced by the low-band speaker 30-1 and the low-band speaker 30-2 provided adjacent to the upper and lower ends of the display 61.

In such a manner, sufficient sound pressure of sounds of content is securable, and therefore sound quality deterioration of sounds of contents is avoidable. In other words, the sound reproducing apparatus 11 reproduces a high band by using the reflection speaker 24, and reproduces a low band by using the low-band speakers 30. Accordingly, high sound quality content reproduction is achievable in a full range from the low band to the high band.

Further, for reproduction of low-band components of sounds of content, the sound reproducing apparatus 11 carries out (achieves) panning by performing signal processing such as gain adjustment with use of the gain adjustment units 26, a delay process with use of the delay units 29, and gain adjustment with use of signal processing circuits provided inside the low-band speakers 30, for example.

In such a manner, a sound image of low-band components of sounds of content is also localized at a desired position. In addition, each of the low-band speakers 30 in this example is a line sound source. Accordingly, sound emission positions of the low-band components are not easily perceivable for the listener.

In the example described above, frequency components at 4 kHz or higher in sounds of content can be reproduced by the reflection speaker 24 as the high-band components, and frequency components at 4 kHz or lower in sounds of content can be reproduced by the low-band speakers 30 as the low-band components, for example.

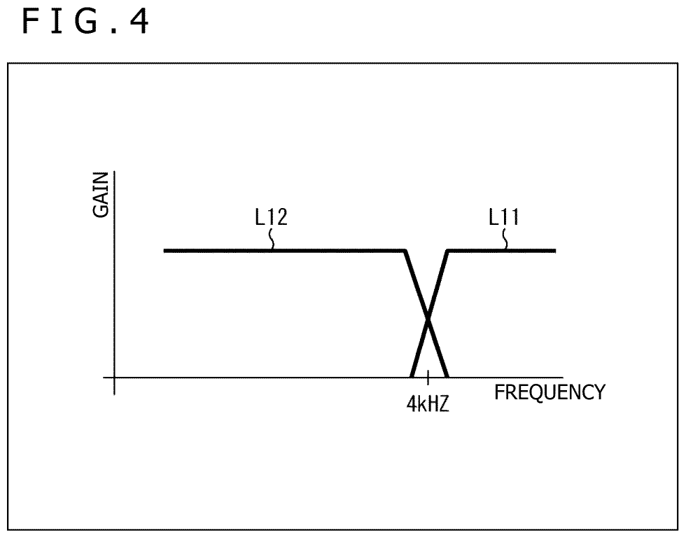

In this case, the HPF 23 and LPFs 28 have frequency characteristics depicted in FIG. 4, for example. Note that a vertical axis represents a gain and that a horizontal axis represents a frequency in FIG. 4.

In the example presented in FIG. 4, a polygonal line L11 represents frequency characteristics of the HPF 23, while a polygonal line L12 represents frequency characteristics of each of the LPFs 28. In this example, a frequency at a position of an intersection between the polygonal line L11 and the polygonal line L12 is 4 kHz.

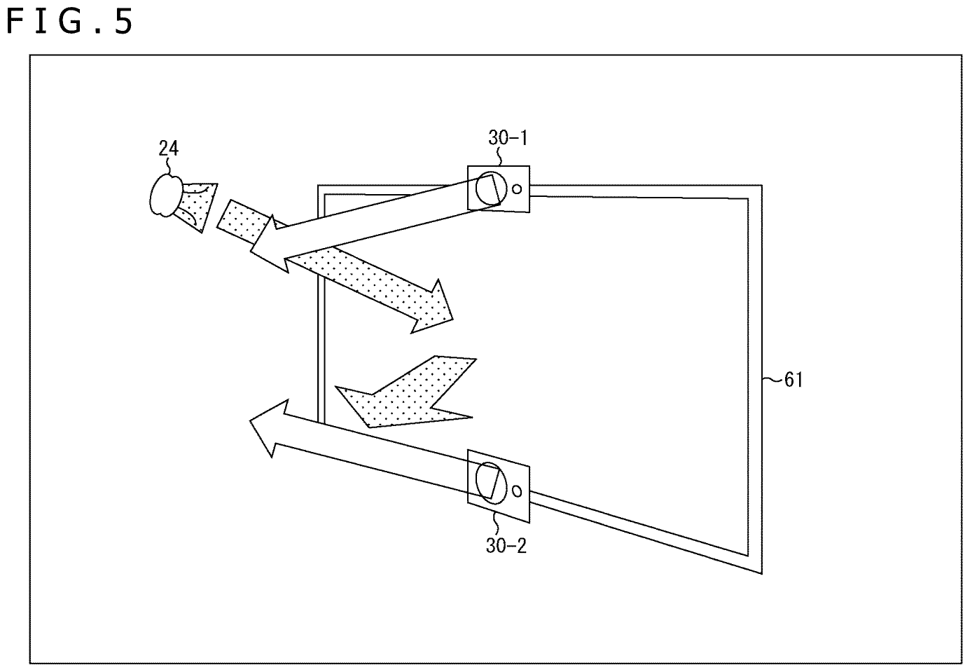

Moreover, while the example of using an array speaker as each of the low-band speakers 30 has been described with reference to FIG. 3, each of the low-band speaker 30 may be a speaker constituting a point sound source as depicted in FIG. 5, for example.

In the example depicted in FIG. 5, the reflection speaker 24 is a horn tweeter and is disposed at a position similar to that position in FIG. 3.

On the other hand, each of the low-band speakers 30 is a speaker constituting a point sound source. In this example, the low-band speaker 30-1 and the low-band speaker 30-2 are disposed adjacent to center positions of the upper and lower ends of the display 61, respectively.

In this example, frequency components at 4 kHz or higher in sounds of content can be reproduced by the reflection speaker 24, while frequency components at 4 kHz or lower in sounds of content can be reproduced by the low-band speakers 30, for example. Moreover, during reproduction of the low-band components, the sound reproducing apparatus 11 can carry out panning to localize a sound image of the low-band components within the screen of the display 61.

While the example in which pictures of content are reproduced by the display 61 has been described above, pictures of content may be reproduced by a projector or other devices, for example, instead of a display.

For example, in a case where pictures of content are reproduced by a projector, the low-band speakers 30 are only required to be disposed at positions adjacent to a picture (image) display surface where the pictures of the content are displayed (projected), such as a screen and a wall.

### <Directivity Control by Low-Band Speaker>

Further, in a case where the low-band speakers 30 are capable of performing directivity control, such as a case where the low-band speakers 30 are array speakers, sound quality of content can be further improved.

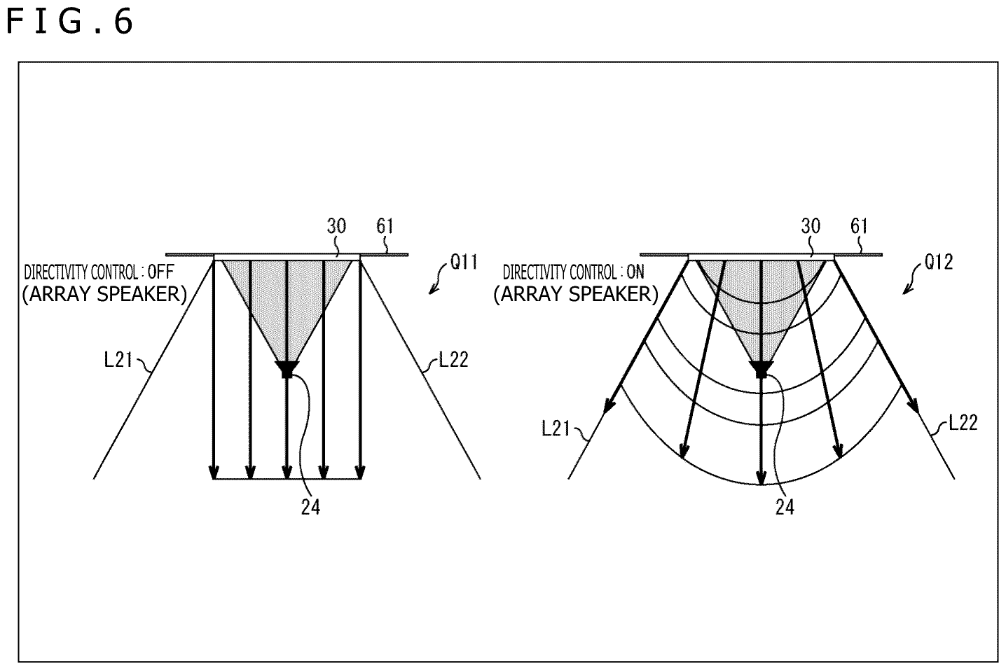

For example, as indicated by an arrow Q11 in FIG. 6, it is assumed that sounds corresponding to high-band components output from the reflection speaker 24 are reflected on the display 61 and travel in a direction toward the listener while spreading in a range from a line L21 to a line L22.

In this case, if sounds corresponding to low-band components are reproduced by array speakers functioning as the low-band speakers 30 without directivity control, the sounds corresponding to the low-band components travel in the direction toward the listener without substantial spread of the sounds as indicated by arrows in the figure. Accordingly, the sounds corresponding to the high-band components and the sounds corresponding to the low-band components propagate in the direction toward the listener by spread degrees (conditions) different from each other.

If the spread degree of the sounds corresponding to the high-band components and the spread degree of the sounds corresponding to the low-band components differ from each other as described above, the listener hears these sounds as if they are coming in different directions.

Moreover, if the spread degrees of the sounds corresponding to the high-band components and the sounds corresponding to the low-band components differ from each other, interference fringes are generated by wave fronts (sound waves) of these sounds. As a result, sound quality of sounds of content is deteriorated. Generation of these interference fringes produces a state of formation of a comb filter.

Accordingly, in a case where each of the low-band speakers 30 is an array speaker or the like and has a directivity control function, for example, the low-band speakers 30 may perform directivity control to equalize the spread degrees of the sounds corresponding to the high-band components and the sounds corresponding to the low-band components as indicated by arrows Q12.

In other words, the low-band speakers 30 may perform signal processing for directivity control so as to output sounds propagating by substantially the same degree as the spread degree of sounds output from the reflection speaker 24 and reflected on the display 61.

In the part indicated by the arrows Q12, each of the arrows in the figure represents an emission direction (propagation direction) of the sounds output from each of the low-band speakers 30. It is apparent, in this example, that the sounds corresponding to the high-band components and the sounds corresponding to the low-band components spread and propagate in the direction toward the listener in a similar manner.

In the manner described above, the directions felt by the listener as directions where the sounds corresponding to the high-band components and the sounds corresponding to the low-band components are heard can be equalized with each other, and generation of interference fringes can be reduced to improve sound quality.

In addition, in a case where a plurality of sound signals, such as sound signals from a plurality of sound sources and channels, is supplied to the sound reproducing apparatus 11, the low-band speakers 30 are only required to perform directivity control for equalizing the spread degrees of the sounds corresponding to the high-band components and the sounds corresponding to the low-band components for each of these sound signals.

Moreover, there is also such a case where the low-band speakers 30 are unable to change directivity. In this case, for example, each of the low-band speakers 30 is only required to be used as a speaker which has directivity for outputting sounds propagating by substantially the same spread degree as the spread degree of sounds output from the reflection speaker 24 and reflected on the display 61. For example, it is considered to adopt a horn-type speaker or the like for this type of the low-band speakers 30.

### <Precedence Sound Effect>

The sound reproducing apparatus 11 further includes the delay unit 25 which utilizes a precedence sound effect to enable the listener to perceive that a sound emission position, i.e., a localization position of a sound image is located at a reflection position of a sound emitted from the reflection speaker 24 within the screen of the display 61.

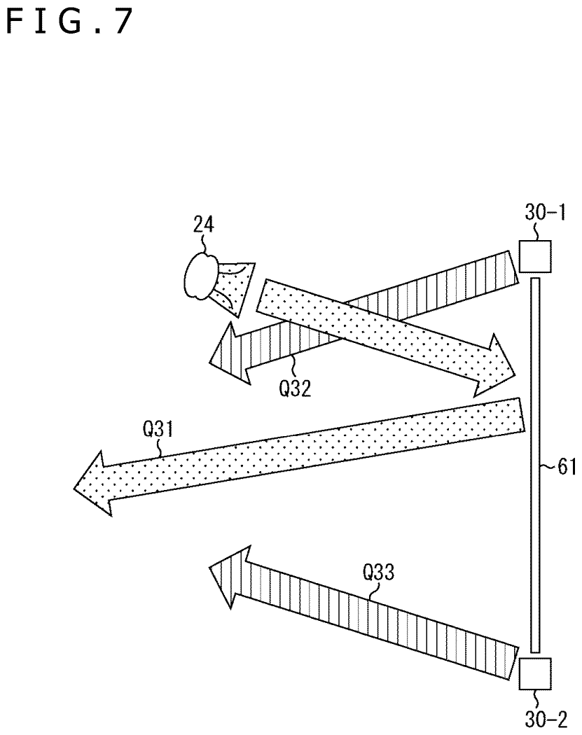

Specifically, as indicated by an arrow Q31 in FIG. 7, for example, a sound based on a high-band signal output from the reflection speaker 24, i.e., a sound corresponding to a high-band component of content is reflected at a predetermined position within the screen of the display 61, and reaches the listener.

On the other hand, a sound based on a low-band signal output from each of the low-band speakers 30, i.e., a sound corresponding to a low-band component of content directly reaches the listener from each of the low-band speakers 30 as indicated by arrows Q32 and Q33.

In a case where sounds come to the listener in a plurality of directions as described above, it is generally known that these sounds are heard as if they are coming in a coming direction of the sound arriving at the listener earlier. This effect (phenomenon) is called a precedence sound effect.

Accordingly, the sound reproducing apparatus 11 performs a delay process for sound signals with use of the delay unit 25 such that sounds output from the reflection speaker 24 and reflected on the display 61 can reach the listener earlier than sounds output from the low-band speakers 30.

By this process, output timing of the sounds from the low-band speakers 30 is delayed from output timing of the sounds from the reflection speaker 24 by a delay time produced by the delay unit 25. In other words, the sound from the reflection speaker 24 can be output earlier than the sounds from the low-band speakers 30.

Accordingly, by appropriate adjustment of the delay time of the delay unit 25, the sounds from the reflection speaker 24 can heard by the listener first, and the sounds from the low-band speakers 30 can be heard by the listener immediately after the sounds from the reflection speaker 24.

In such a manner, not only the sounds output from the reflection speaker 24 but also the sounds output from the low-band speakers 30 can be felt by the listener as if these sounds are heard in the coming direction of the sounds from the reflection speaker 24. In other words, a sound image of sounds of content can be localized at a reflection position of sounds output from the reflection speaker 24 within the screen of the display 61.

<Description about Reproduction Process>

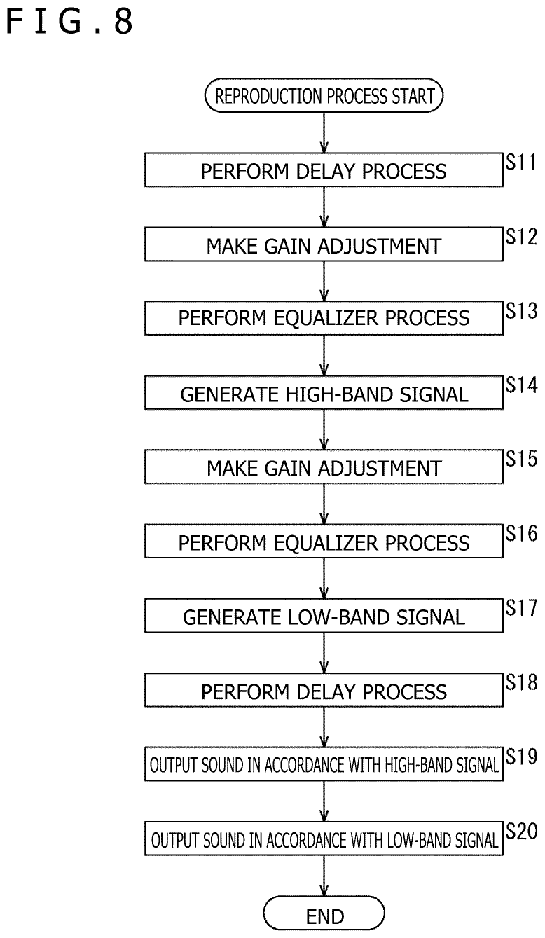

An operation of the sound reproducing apparatus 11 will be subsequently described. Specifically, a reproduction process performed by the sound reproducing apparatus 11 will be hereinafter described with reference to a flowchart in FIG. 8.

In step S11, the delay unit 25 performs a delay process for delaying a supplied sound signal by a predetermined time, and then supplies the sound signal to the gain adjustment unit 26. In step S11, the sound signal is delayed by a length sufficient for producing the precedence sound effect described above.

In step S12, the gain adjustment unit 21 makes gain adjustment for the supplied sound signal and supplies the sound signal after gain adjustment to the equalizer 22.

In step S13, the equalizer 22 performs an equalizer process for the sound signal supplied from the gain adjustment unit 21 and supplies the sound signal obtained by this process to the HPF 23.

In step S14, the HPF 23 filters the sound signal supplied from the equalizer 22 with use of an HPF to generate a high-band signal and supplies the obtained high-band signal to the reflection speaker 24.

In step S15, each of the gain adjustments unit 26 makes gain adjustment for the sound signal supplied from the delay unit 25 and supplies the sound signal after gain adjustment to the equalizer 27.

In step S16, each of the equalizers 27 performs an equalizer process for the sound signal supplied from the gain adjustment unit 26 and supplies the sound signal obtained by this process to the LPF 28.

In step S17, each of the LPFs 28 filters the sound signal supplied from the equalizer 27 with use of an LPF to generate a low-band signal, and supplies the obtained low-band signal to the delay unit 29.

In step S18, each of the delay units 29 performs a delay process for delaying the low-band signal supplied from the LPF 28 by a predetermined time, and then supplies the low-band signal to the low-band speaker 30.

In step S19, the reflection speaker 24 outputs a sound corresponding to a high-band component of content on the basis of the high-band signal supplied from the HPF 23.

Specifically, the reflection speaker 24 outputs the sound toward a display surface where pictures of the content are displayed, such as the display 61. This sound is reflected on the display surface and reaches the listener.

In addition, in a case where directivity is dynamically controllable, such as a case where the reflection speaker 24 is an array tweeter or a beam tweeter, the reflection speaker 24 performs signal processing for directivity control of the high-band signal to cause the sound to reflect at a desired position on the display surface, and then outputs the sound based on the high-band signal.

For example, in a case where the reflection speaker 24 is an array tweeter, the reflection speaker 24 performs signal processing for the high-band signal for each of tweeters constituting the array tweeter to generate a speaker driving signal supplied to each of these tweeters.

For the signal processing for each of the tweeters, a delay process for the high-band signal, filtering with use of a filter such as FIR (Finite impulse response), gain adjustment, and the like are executed as necessary, for example.

At this time, in a case where position information indicating a sound source position of any sound included in sounds of the content, such as a position of a sound source within a picture of the content and a position of a sound source within a space, can be supplied from the outside, the reflection speaker 24 may perform the signal processing for directivity control for each of the tweeters on the basis of the position information.

In step S20, each of the low-band speakers 30 outputs a sound on the basis of a low-band signal supplied from the delay unit 29 to reproduce a low-band component of a sound of the content.

At this time, in a case where directivity is controllable, such as a case where each of the low-band speakers 30 is an array speaker, each of the low-band speakers 30 performs signal processing for directivity control of the low-band signal, and then outputs a sound based on the low-band signal.

This signal processing equalizes spread degrees of sounds from the reflection speaker 24 and sounds from the low-band speakers 30 and achieves panning, for example.

For example, as in the case of the reflection speaker 24, each of the low-band speakers 30 performs, as the signal processing for directivity control, a delay process, filtering with use of a filter such as FIR, gain adjustment, and the like for each of a plurality of speakers (speaker units) constituting the low-band speaker 30.

In this case, as in the case of the reflection speaker 24, position information associated with a sound source may be used for the signal processing performed by each of the low-band speakers 30 as necessary. Moreover, panning carried out by the two low-band speakers 30 may be achieved by any processing, such as one of signal processing performed within each of the low-band speakers 30, gain adjustment with use of each of the gain adjustment units 26, and a delay process with use of each of the delay units 29, and any combination of a plurality of these processes.

When sounds of the content are reproduced by output of sounds from the reflection speaker 24 and the low-band speakers 30, the reproduction process ends.

In the manner described above, the sound reproducing apparatus 11 outputs sounds corresponding to high-band components of content from the reflection speaker 24 and causes these sounds to reflect on the content picture display surface, and also reproduces sounds corresponding to low-band components of the content by panning with use of the low-band speakers 30. In such a manner, appropriate sound image localization is realizable without deteriorating sound quality.

Particularly, the effect of localizing a sound image at an appropriate position can be further improved by performing the delay process such that sounds from the reflection speaker 24 can reach the listener earlier than sounds from the low-band speakers 30.

Moreover, sound quality of sounds of content can be improved by causing sounds from the reflection speaker 24 and sounds from the low-band speakers 30 to spread in the same direction, i.e., matching (equalizing) spread degrees of these sounds under directivity control performed by the low-band speakers 30.

### Different Example of Speaker Arrangement

Incidentally, while FIG. 2 depicts the sound reproducing apparatus 11 including the one reflection speaker 24 and the two low-band speakers 30 by way of example, each of the numbers of the reflection speakers and the low-band speakers to be provided may be any number.

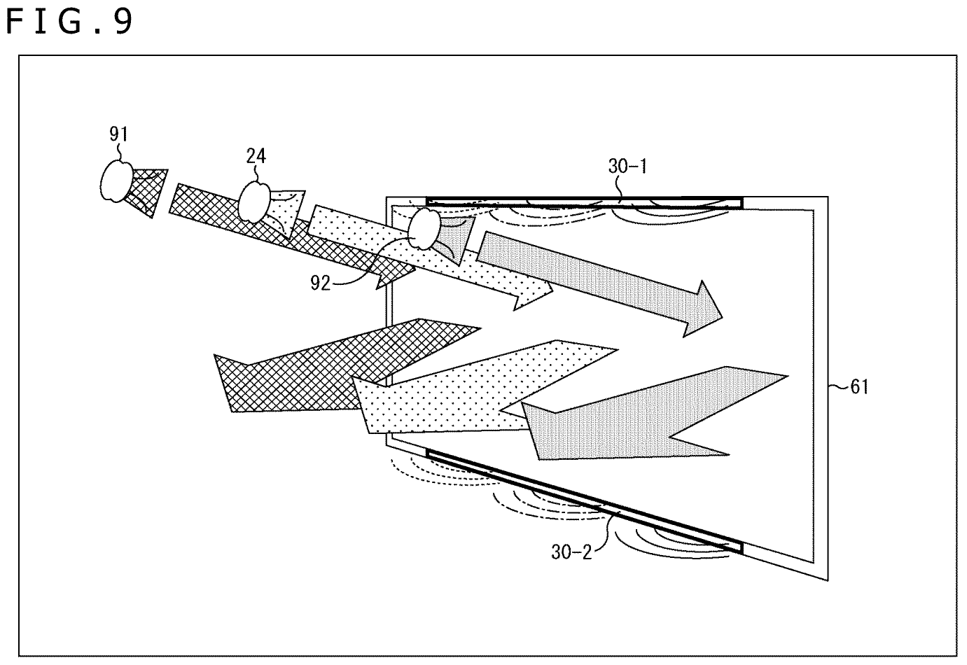

For example, as depicted in FIG. 9, the sound reproducing apparatus 11 may further include a reflection speaker 91 and a reflection speaker 92 as a speaker for high-band component reproduction in addition to the reflection speaker 24. Note that parts in FIG. 9 identical to corresponding parts in FIG. 3 are given identical reference signs, and description of these parts will be omitted where appropriate.

Each of the reflection speaker 91 and the reflection speaker 92 is a speaker provided for high-band component reproduction and capable of controlling directivity similarly to the reflection speaker 24.

For example, each of the reflection speaker 24, the reflection speaker 91, and the reflection speaker 92 is a horn tweeter or the like, while each of the low-band speakers 30 is an array speaker or the like.

Moreover, as in the case depicted in FIG. 4, frequency components at 4 kHz or higher in sounds of content are reproduced by the reflection speaker 24, the reflection speaker 91, and the reflection speaker 92, and frequency components at 4 kHz or lower in sounds of content are reproduced by the low-band speakers 30, for example.

The sound reproducing apparatus 11 includes a gain adjustment unit, an equalizer, and an HPF similar to the gain adjustment unit 21 to the HPF 23 and disposed in a stage before each of the reflection speaker 91 and the reflection speaker 92 similarly to the case of the reflection speaker 24.

In this example, the reflection speaker 24, the reflection speaker 91, and the reflection speaker 92 are arranged side by side in a lateral direction of the display 61 in an upper part of the front of the display 61.

According to this speaker arrangement, a sound image localization position can be fixedly defined for each of the reflection speakers. Specifically, the plurality of reflection speakers may each output sounds toward a different region on the display screen of the display 61.

For example, sounds output from the reflection speaker 24 may be reflected on a central region of the display screen of the display 61, sounds output from the reflection speaker 91 may be reflected on a left region of the display screen of the display 61, and sounds output from the reflection speaker 92 may be reflected on a right region of the display screen of the display 61.

In this case, the sounds from the reflection speaker 24 are localized at the center of the display screen of the display 61 as viewed from the listener. In addition, the sounds from the reflection speaker 91 are localized on the left side within the display screen of the display 61 as viewed from the listener, while the sounds from the reflection speaker 92 are localized on the right side within the display screen of the display 61 as viewed from the listener.

Accordingly, this example allows multi-divisional driving which causes the reflection speaker 24 to reproduce sounds from C channel of content, the reflection speaker 91 to reproduce sounds from L channel of content, and the reflection speaker 92 to reproduce sounds from R channel of content, for example.

In this case, for example, an array speaker functioning as each of the low-band speakers 30 performs directivity control for equalizing spread degrees of sounds from the reflection speaker and sounds from the low-band speakers 30 for each of the reflection speakers, i.e., for each of L, C, and R channels.

At this time, for example, the sounds from C channel can be chiefly output from the speaker disposed at the center of each of the array speakers functioning as the low-band speakers 30, the sounds from L channel can be chiefly output from the speaker disposed on the left part of each of the array speakers in the figure, and the sounds from R channel can be chiefly output from the speaker disposed on the right part of each of the array speakers in the figure.

Such directivity control can reduce generation of interference fringes by equalizing spread degrees of sounds corresponding to high-band components and sounds corresponding to low-band components in each of the channels and also decrease crosstalk (interference) of sounds between the channels. Accordingly, improvement of sound quality is achievable.

### Example of Directivity Control

In addition, an object corresponding to a sound source shifts in a picture of content in some cases. Accordingly, in a case where position information indicating a position of a shifting sound source is acquirable for each of times by using any method, a sound image of sounds of content may be shifted by directivity control.

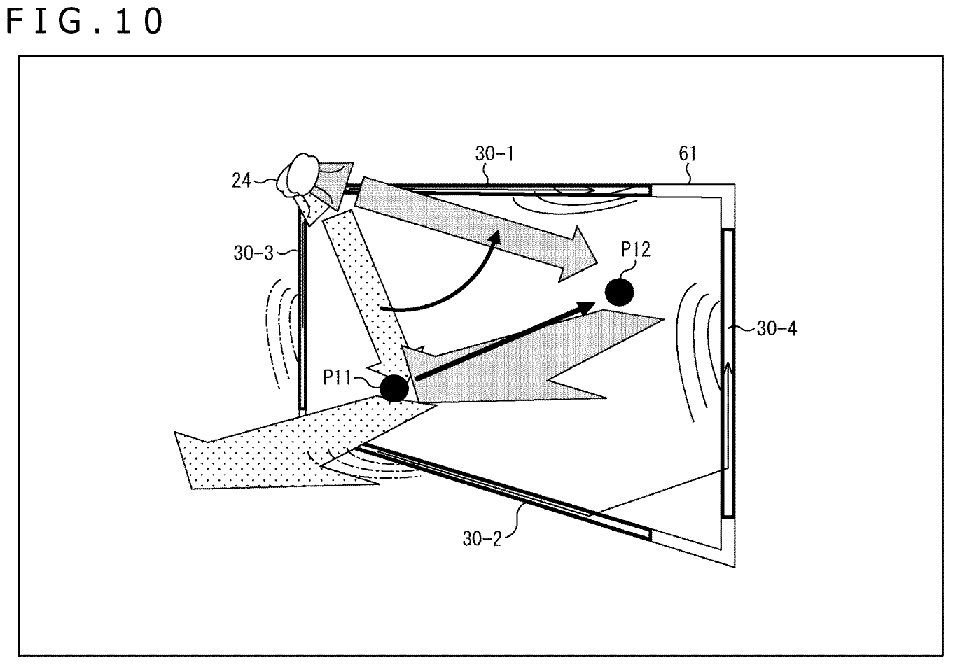

In this case, for example, a reflection position of a sound from the reflection speaker 24 is only required to be shifted (changed) within the display screen of the display 61 as depicted in FIG. 10.

In this example, the reflection speaker 24 is a horn tweeter, and a not-depicted drive unit (drive mechanism) provided on the sound reproducing apparatus 11 is connected to the reflection speaker 24. For example, the drive unit is capable of changing a direction of the reflection speaker 24 by rotating the reflection speaker 24 such that the reflection speaker 24 faces in a desired direction or by other methods.

Moreover, the low-band speaker 30-1 to a low-band speaker 30-4 are disposed at upper, lower, left, and right ends of the display screen of the display 61, respectively.

Each of the low-band speaker 30-3 and the low-band speaker 30-4 herein is a speaker for reproducing low-band components of sounds of content similarly to the low-band speaker 30-1 and the low-band speaker 30-2. In this example, each of the low-band speaker 30-1 to the low-band speaker 30-4 is an array speaker.

Note that each of the low-band speaker 30-1 to the low-band speaker 30-4 will be also simply referred to as the low-band speaker 30 hereinbelow in a case where no particular distinction between these speakers is needed.

In this example, as in the case depicted in FIG. 4, frequency components at 4 kHz or higher in sounds of content are reproduced by the reflection speaker 24, while frequency components at 4 kHz or lower in sounds of content are reproduced by the low-band speaker 30-1 to the low-band speaker 30-4, for example.

For example, it is assumed that a sound source is located at a position P11 on the display screen of the display 61, and that the reflection speaker 24 also outputs a sound toward the position P11 such that this sound reflects at the position P11.

At this time, it is assumed that each of the low-band speaker 30-1 to the low-band speaker 30-4 also outputs a sound corresponding to a low-band component in such a manner that the listener perceives as if the respective sounds are coming in the direction from the position P11 by panning. For example, the respective speakers are controlled herein such that sounds are chiefly output from the speakers located near the position P11 in the low-band speaker 30-2 and the low-band speaker 30-3 and such that no sound is substantially output from the low-band speaker 30-1 and the low-band speaker 30-4.

Suppose that the position of the sound source shifts from the position P11 to a position P12 in such a state.

In this case, the drive unit turns the reflection speaker 24 in a direction toward the position P12 by rotating the reflection speaker 24 on the basis of position information indicating the position P12. As a result, the sound output from the reflection speaker 24 reflects at the position P12 where the sound source is located, and then reaches the listener. In other words, a sound image of the sound from the reflection speaker 24 is localized at the position P12 within the display screen of the display 61.

Accordingly, the listener feels as if the sound image of the sound coming from the reflection speaker 24 has shifted from the position P11 to the position P12.

Moreover, in accordance with the shift of the sound image of the sound from the reflection speaker 24, each of the low-band speakers 30 also performs directivity control for panning on the basis of the position information indicating the position P12 such that the listener perceives as if the sound is coming in the direction from the position P12.

In this case, with an elapse of time, the respective speakers are controlled such that sounds are chiefly output from the speakers located near the position P12 in the low-band speaker 30-1 and the low-band speaker 30-4 and such that no sound is substantially output from the low-band speaker 30-2 and the low-band speaker 30-3, for example.

In such a manner, appropriate sound image localization is realizable without deteriorating sound quality even in a case where a sound source position is shifted.

Note that the position information indicating the positions of the sound source such as the position P11 and the position P12 may be input by a user or the like, or may be prepared beforehand as metadata of sound signals. For example, for object audios or the like, position information indicating positions of objects within a space is included in metadata of sound signals for the respective objects.

Alternatively, for example, DNN (Deep Neural Network) which receives input of at least either one of picture signals and sound signals of content and outputs position information may be learned beforehand, and the sound reproducing apparatus 11 may generate position information by using the DNN.

In addition, in a case where the reflection speaker 24 is an array tweeter, a beam tweeter, a flat speaker, or the like, a reflection position of sounds from the reflection speaker 24, i.e., a shift of a sound image position can be achieved by directivity control performed by the reflection speaker 24 on the basis of position information.

### Example 1 of Reflection Speaker

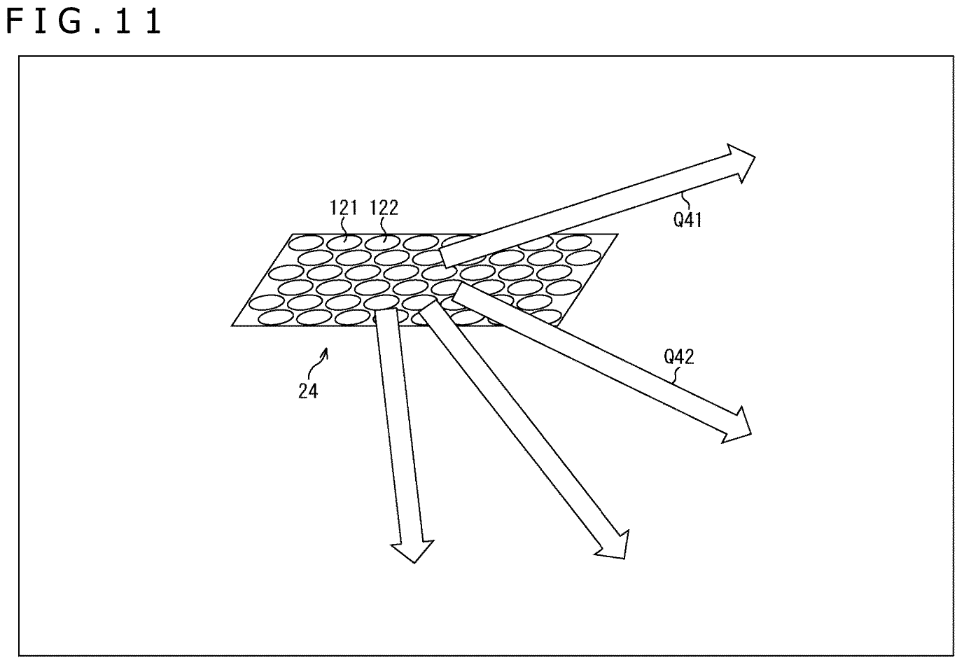

As described above, the reflection speaker 24 may be any type of reflection speaker as long as directivity control is achievable. The reflection speaker 24 can be used as a two-dimensional array tweeter as depicted in FIG. 11.

In the example depicted in FIG. 11, the reflection speaker 24 is an array tweeter having a face shape obtained by arranging a plurality of tweeters including a tweeter 121 and a tweeter 122 on a two-dimensional plane.

This type of array tweeter is capable of realizing directivity control by signal processing such as the delay process described above, filtering with use of a filter such as an FIR, and gain adjustment to output sounds based on high-band signals, i.e., sound beams by a desired spread degree in a desired direction. In other words, directivity (directional characteristics) and directions (propagation directions) of the sound beams to be output are freely changeable by directivity control.

Particularly, such directivity control is achievable for each sound source or channel, i.e., for each of a plurality of high-band signals. Accordingly, for example, sounds based on high-band signals generated from a plurality of sound signals and associated with these sound signals are simultaneously reproducible. For example, sounds from L, C, and R channels can be simultaneously output in different directions by different spread degrees.

Specifically, for example, sounds from L channel are output in a direction indicated by an arrow Q41, and sounds from C channel are output in a direction indicated by an arrow Q42 during the output of the sounds from L channel. In such a manner, sounds from different sound sources or channels can be output in directions different from each other, such as directions toward the front and an oblique direction.

Moreover, the array tweeter functioning as the reflection speaker 24 is capable of achieving a shift of a sound image as described with reference to FIG. 10, i.e., a shift (change) of a reflection position of sounds on the display 61 by directivity control.

Accordingly, in a case where the reflection speaker 24 is used as an array tweeter, it is not necessary to prepare the same number of array tweeters as the number of sound sources or channels as in a case of using a horn tweeter. As a result, reproduction of sounds of a plurality of sources or channels is achievable by using a single array tweeter.

Further, for shifting a sound image, a horn tweeter itself needs to physically change the direction of the horn tweeter. However, an array tweeter is capable of freely shifting a sound image independently for each of a plurality of sound sources and channels only by directivity control without a necessity of physically moving the array tweeter itself.

In addition, a horn tweeter is large in size, incapable of changing directivity after installation, and only capable of realizing directivity for spreading sounds, for example. Accordingly, a horn tweeter may have a limited installation position.

On the other hand, the array tweeter depicted in FIG. 11 has a thin plate shape (face shape), is therefore easily installed on a ceiling, a wall, or the like, and is capable of performing directivity control by signal processing. Accordingly, the array tweeter is excellent not only in reduction of a limitation to its installation position, but also in view of design.

For example, the array tweeter has a face shape and a small size, and therefore does not deteriorate the appearance even when installed on a ceiling or a wall inside a room. Accordingly, the array tweeter is excellent in view of design.

Moreover, for example, even when the array tweeter is installed at any position such as a position excellent in design within a space, sounds can be reflected at any position within a display surface such as the display 61 under directivity control.

Furthermore, the array tweeter is capable of limiting a region where sounds of content are heard by directivity control.

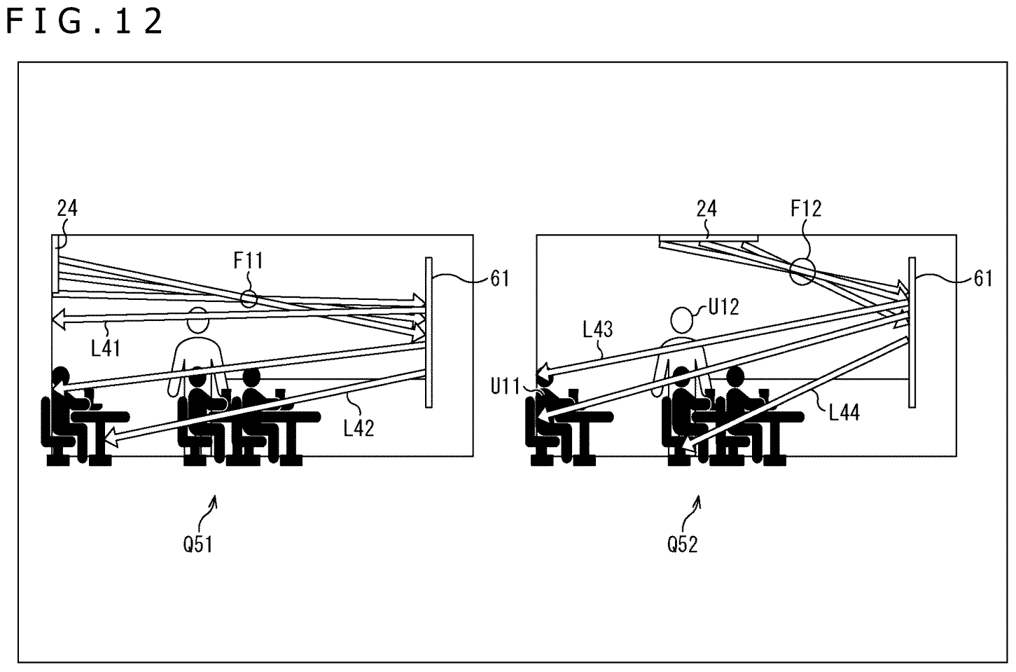

For example, suppose that an array tweeter having a face shape and functioning as the reflection speaker 24 is installed on a wall inside a room as indicated by an arrow Q51 in FIG. 12. In this example, a surface of the reflection speaker 24 and the display screen of the display 61 are in a state parallel with each other.

When the reflection speaker 24 outputs sounds under directivity control in such a state, these sounds propagate in a manner indicated by arrows in the figure, and focus on the front side of the display 61, i.e., on a position F11 between the reflection speaker 24 and the display 61. In other words, sounds (sound waves) output from a plurality of tweeters constituting the array tweeter as the reflection speaker 24 converge (concentrate) on the position F11 before reaching the display 61.

Thereafter, the sounds (sound waves) output from the plurality of tweeters spread in a space between the position F11 to the display 61, reflect on the display screen of the display 61, and propagate in directions toward listeners while spreading in such a state.

Accordingly, in this example, sounds from the reflection speaker 24 are heard by only users (listeners) located in a region between an arrow L41 and an arrow L42 in front of the display 61, but not heard by users located out of the region.

In addition, as indicated by an arrow Q52 in FIG. 12, in a case where the array tweeter having a face shape and functioning as the reflection speaker 24 is installed in a ceiling inside the room, directivity control which forms a region where sounds from the reflection speaker 24 are heard and a region where these sounds are not heard is also achievable similarly to the example indicated by the arrow Q51.

In the example depicted by the arrow Q52, the surface of the reflection speaker 24 and the display screen of the display 61 are in a state perpendicular to each other.

When the reflection speaker 24 outputs sounds under directivity control in such a state, these sounds propagate in a manner indicated by arrows in the figure, and focus on a position F12 in front of the display 61. In other words, sounds (sound waves) output from a plurality of tweeters constituting the array tweeter as the reflection speaker 24 converge on the position F12.

Thereafter, the sounds (sound waves) output from the reflection speaker 24 spread in a space between the position F12 to the display 61, reflect on the display screen of the display 61, and then propagate in directions toward the listeners while further spreading.

Accordingly, similarly in this example, sounds from the reflection speaker 24 are heard by only user (listeners) located in a region between an arrow L43 and an arrow L44 in front of the display 61, but not heard by users located out of the region.

Such directivity control is particularly useful in a case where content is desired to be heard by only users located in a particular region, such as a case where content is heard by a user U11 and the like who are sitting, and not heard by a user U12 who is standing, for example.

Moreover, as depicted in FIG. 12, the array tweeter is capable of outputting sounds in any direction with any directivity, such as positioning a focal point of sound waves at any location by directivity control.

Accordingly, the degree of freedom of the installation position and the direction of the array tweeter can be increased.

### Example 2 of Reflection Speaker

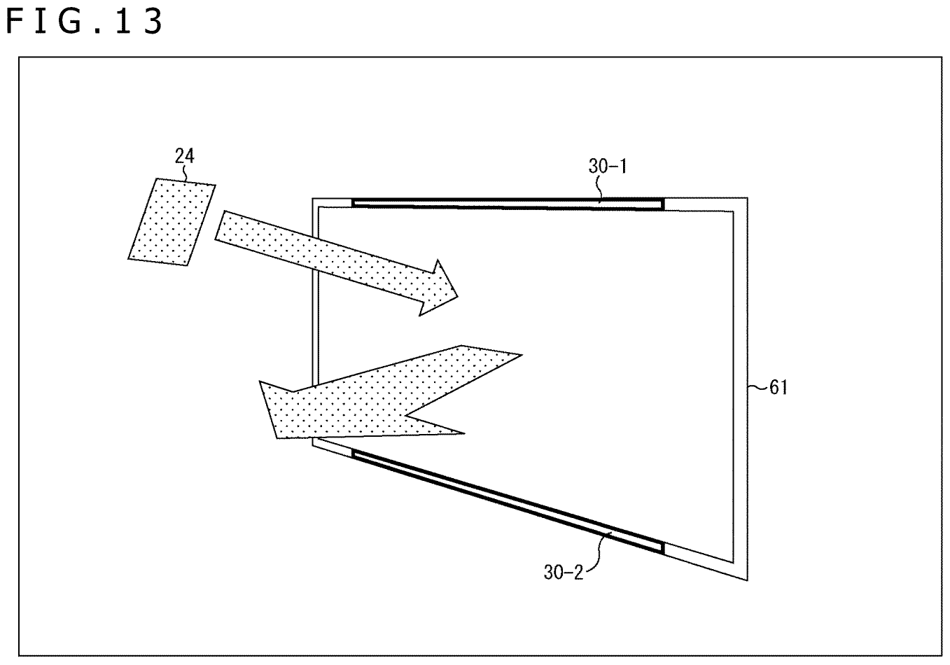

In addition, the reflection speaker 24 may be used as a flat speaker having a flat plate shape (face shape) as depicted in FIG. 13.

In the example of FIG. 13, a flat speaker having a flat shape and functioning as the reflection speaker 24 is disposed on the upper front side of the display 61, while array speakers functioning as the low-band speakers are disposed at the upper and lower ends of the display screen of the display 61.

The flat speaker has a structure which achieves directivity control by deforming (bending) a plate-shaped diaphragm of the flat speaker.

Sounds output from the flat speaker functioning as the reflection speaker 24 reflect on the display screen of the display 61 and propagate in a direction toward the listener.

In this case, as in the example depicted in FIG. 4, frequency components at 4 kHz or higher in sounds of content can be reproduced by the reflection speaker 24, and frequency components at 4 kHz or lower in sounds of content can be reproduced by the low-band speakers 30, for example.

Moreover, the flat speaker is small-sized and face-shaped similarly to the array tweeter, is therefore more easily installed on a ceiling, a wall, or the like than a horn tweeter, and is capable of performing directivity control by deformation of the diaphragm. Accordingly, the flat speaker is excellent not only in reduction of a limitation to its installation position, but also in view of design.

Similarly to the array tweeter, even when the flat speaker is installed at any position such as a position excellent in view of design within a space, for example, sounds can be reflected at any position within the display screen of the display 61 under directivity control.

Moreover, similarly to the array tweeter, the flat speaker is capable of outputting sounds in any direction with any directivity, such as positioning a focal point of sound waves at any location by directivity control. Accordingly, the degree of freedom of the installation position and the direction of the flat speaker can be increased.

### Example 3 of Reflection Speaker

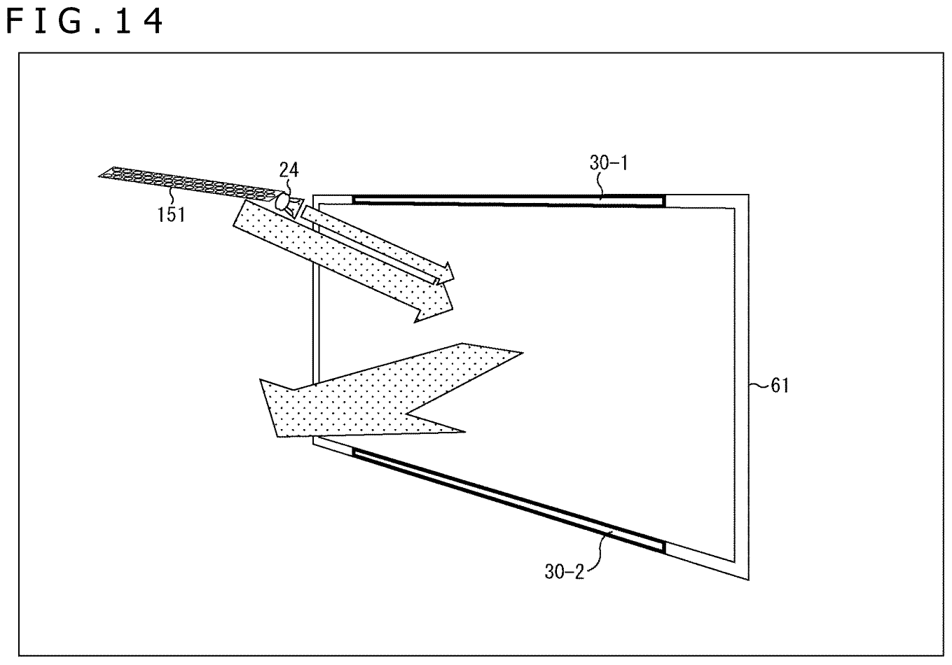

Further, for example, sounds of content may be reproduced by using a plurality of reflection speakers each having a different reproduction band as depicted in FIG. 14.

In this example, a horn tweeter functioning as the reflection speaker 24 and an array tweeter functioning as a reflection speaker 151, which is a different reflection speaker, are disposed on the upper front side of the display 61, while array speakers functioning as the low-band speakers 30 are disposed at the upper and lower ends of the display screen of the display 61.

Particularly, the reflection speaker 24 and the reflection speaker 151 are disposed side by side on a ceiling or the like inside a room. Sounds output from the reflection speaker 24 and the reflection speaker 151 are reflected at substantially the same position on the display screen of the display 61 and propagate in a direction toward the listener.

If all components at frequencies equal to or higher than 4 kHz in sounds of content are reproduced by a horn tweeter functioning as the reflection speaker 24, for example, a horn constituting the horn tweeter becomes large-sized. In this case, the installation position of the reflection speaker 24 is limited.

On the other hand, an array tweeter functioning as the reflection speaker 151 has a directivity control limitation dependent on a distance between tweeters constituting this array tweeter. For example, an upper limit of a directivity-controllable frequency band of an array tweeter which includes tweeters each having a diameter of 20 mm is in a range from 8 to 10 kHz.

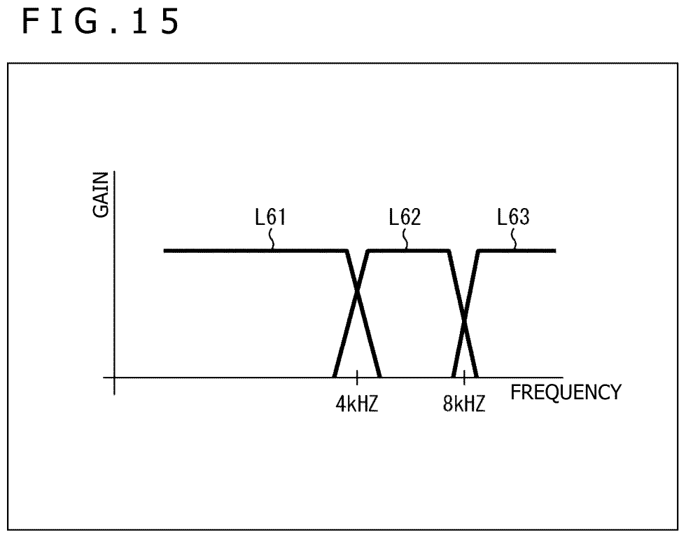

Accordingly, in this example, frequency components in a range from 4 to 8 kHz are reproduced by the reflection speaker 151 (array tweeter), while frequency components equal to or higher than 8 kHz are reproduced by the reflection speaker 24 (horn tweeter) as described in FIG. 15, for example.

Note that a vertical axis and a horizontal axis in FIG. 15 represent a gain and a frequency, respectively.

In the example depicted in FIG. 15, a polygonal line L61 represents a frequency band reproduced by each of the low-band speakers 30, i.e., frequency characteristics of each of the LPFs 28.

Moreover, a polygonal line L62 represents a frequency band reproduced by the reflection speaker 151 (array tweeter), i.e., frequency characteristics of a BPF (Band Pass Filter) provided in a stage before the reflection speaker 151, while a polygonal line L63 represents a frequency band reproduced by the reflection speaker 24 (horn tweeter), i.e., frequency characteristics of the HPF 23.

Particularly, a frequency at a position of an intersection between the polygonal line L61 and the polygonal line L62 is 4 kHz, while a frequency at a position of an intersection between the polygonal line L62 and the polygonal line L63 is 8 kHz.

Accordingly, in high-band components of sounds of content, frequency components in a range from 4 to 8 kHz are reproduced by the reflection speaker 151, and frequency components at 8 kHz or higher are reproduced by the reflection speaker 24. Moreover, frequency components at 4 kHz or lower in sounds of content are reproduced by the low-band speakers 30.

In this case, the horn tweeter functioning as the reflection speaker 24 is rotated by the drive unit described above, and the array tweeter functioning as the reflection speaker 151 performs directivity control by signal processing. In such a manner, a shift of a sound image described with reference to FIG. 10 is achievable.

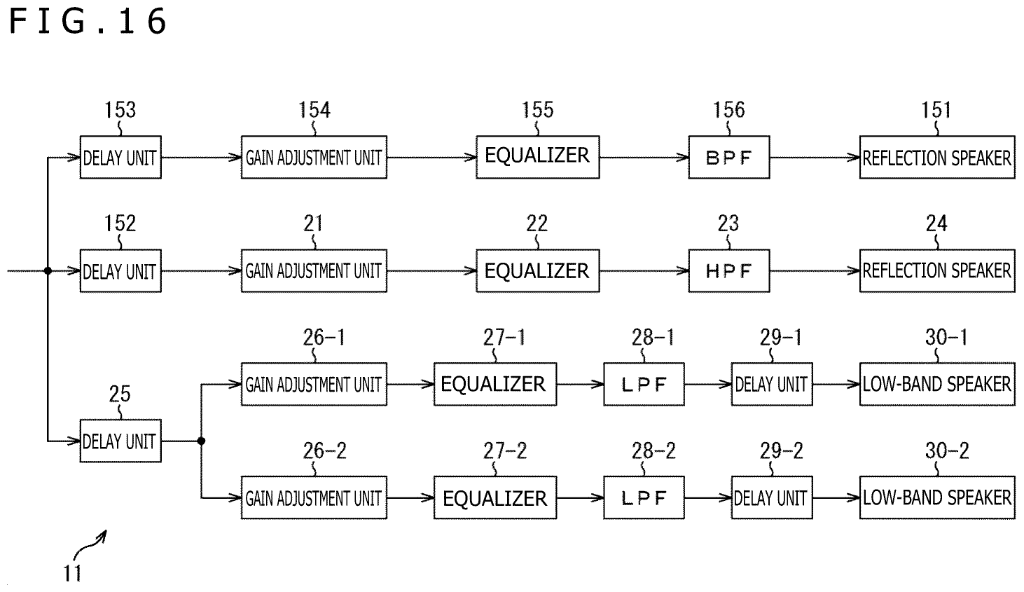

Furthermore, in a case where the reflection speaker 24 and the reflection speaker 151 are provided as depicted in FIG. 14, the sound reproducing apparatus 11 is configured as depicted in FIG. 16, for example. Note that parts in FIG. 16 identical to corresponding parts in FIG. 2 or FIG. 14 are given identical reference signs, and description of these parts will be omitted where appropriate.

The sound reproducing apparatus 11 in the example depicted in FIG. 16 includes a delay unit 152, the gain adjustment unit 21, the equalizer 22, the HPF 23, the reflection speaker 24, a delay unit 153, a gain adjustment unit 154, an equalizer 155, a BPF 156, the reflection speaker 151, the delay unit 25, the gain adjustment unit 26-1, the gain adjustment unit 26-2, the equalizer 27-1, the equalizer 27-2, the LPF 28-1, the LPF 28-2, the delay unit 29-1, the delay unit 29-2, the low-band speaker 30-1, and the low-band speaker 30-2.

The configuration of the sound reproducing apparatus 11 depicted in FIG. 16 has the reflection speaker 151 to the BPF 156 in addition to the components included in the configuration of the sound reproducing apparatus 11 depicted in FIG. 2.

In this example, a sound signal for reproducing a sound of content is supplied to the delay unit 152, the delay unit 153, and the delay unit 25. The delay unit 152 and the delay unit 153 each delay the supplied sound signal by an appropriate time, and then supply the delayed sound signal to the gain adjustment unit 21 and the gain adjustment unit 154, respectively. Note that each of the delay time of the delay unit 152 and the delay time of the delay unit 153 is controlled so as to become an appropriate delay time independently respectively. These delay processes performed by the delay unit 152 and the delay unit 153 are carried out to equalize output timing of sounds from the reflection speaker 24 and the reflection speaker 151.

The gain adjustment unit 154 and the equalizer 155 perform processes similar to the processes performed by the gain adjustment unit 21 and the equalizer 22, respectively.

The BPF 156, which has the frequency characteristics indicated by the polygonal line L62 in FIG. 15, for example, filters a sound signal supplied from the equalizer 155 to allow only components in a specific frequency band to pass, and supplies the signal thus obtained to the reflection speaker 151. The reflection speaker 151 outputs sounds (sound waves), on the basis of the signal supplied from the BPF 156, toward a desired position on a display surface where pictures of content are displayed.

As described above, the reflection speaker 24 and the reflection speaker 151 each reproduce a different frequency band. In such a manner, the horn tweeter functioning as the reflection speaker 24 can be miniaturized. Moreover, directivity uncontrollability caused by the distance between the tweeters of the array tweeter functioning as the reflection speaker 151 is avoidable.

Furthermore, a small-sized device is available as each of the reflection speaker 24 and the reflection speaker 151. This size reduction facilitates installation to a ceiling or a wall inside a room, and therefore contributes to excellence in view of design.

Besides, high-band components of sounds of content are reproduced with division of a frequency band into parts reproduced by the reflection speaker 24 and the reflection speaker 151. Accordingly, each width of the frequency bands reproduced by the reflection speaker 24 and the reflection speaker 151 is narrower than a frequency band in a case of reproduction of the high-band components by the single reflection speaker 24.

Accordingly, direct sounds leaking from the reflection speaker 24 and the reflection speaker 151 and reaching the listener, as a result of directivity uncontrollability of the reflection speaker 24 and the reflection speaker 151, can be reduced. In other words, leakage of sounds, which are not reflection sounds from the display 61 but direct sounds from the reflection speaker 24 and the reflection speaker 151, can be further reduced. In such a manner, for example, the degree of freedom of the installation position of each of the reflection speaker 24 and the reflection speaker 151 can be increased.

### Example 4 of Reflection Speaker

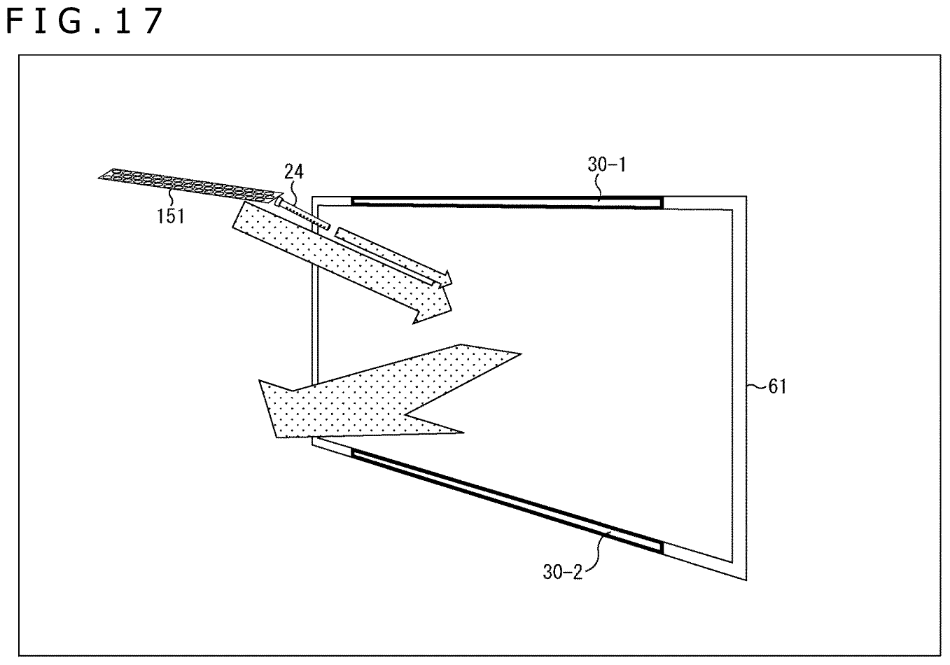

Moreover, in a case of reproduction of high-band components of sounds of content by two reflection speakers, a beam tweeter and an array tweeter may be employed as these speakers as depicted in FIG. 17, for example.

In FIG. 17, a beam tweeter functioning as the reflection speaker 24 and an array tweeter functioning as the reflection speaker 151, which is a different reflection speaker, are disposed on the upper front side of the display 61, while array speakers functioning as the low-band speakers 30 are disposed at the upper and lower ends of the display screen of the display 61.

Particularly in this example, both the reflection speaker 24 and the reflection speaker 151 are disposed side by side on a ceiling or the like inside a room. Sounds output from the reflection speaker 24 and the reflection speaker 151 are reflected at substantially the same position on the display screen of the display 61 and propagate in a direction toward the listener.

If all components at frequencies equal to or higher than 4 kHz in sounds of content are reproduced by the beam tweeter functioning as the reflection speaker 24, for example, leakage of sounds at relatively low frequencies in the frequency band equal to or higher than 4 kHz increases. As a result, crosstalk increases.

The leakage of sounds herein refers to leakage of direct sounds from the reflection speaker 24 to the listener. Crosstalk is a ratio of these direct sounds to reflection sounds reflected on the display 61 and reaching the listener.

Meanwhile, as described above, the array tweeter functioning as the reflection speaker 151 has a directivity control limitation dependent on a distance between tweeters.

Accordingly, in this example, frequency components in a range from 4 to 8 kHz are reproduced by the reflection speaker 151 (array tweeter), while frequency components at 8 kHz or higher are reproduced by the reflection speaker 24 (beam tweeter), as in the example depicted in FIG. 15, for example. Moreover, frequency components at 4 kHz or lower in sounds of content are reproduced by the low-band speakers 30.

In this case, each of the beam tweeter functioning as the reflection speaker 24 and the array tweeter functioning as the reflection speaker 151 performs directivity control by signal processing. In such a manner, a shift of a sound image described with reference to FIG. 10 is achievable.

Each of the beam tweeter functioning as the reflection speaker 24 and the array tweeter functioning as the reflection speaker 151 is small-sized. This size reduction facilitates installation to a ceiling or a wall inside a room, and therefore contributes to excellence in view of design.

Besides, high-band components of sounds of content are reproduced with division of a frequency band into parts reproduced by the reflection speaker 24 and the reflection speaker 151. Accordingly, leakage of direct sounds to the listener can be reduced similarly to the example of FIG. 14. In such a manner, for example, the degree of freedom of the installation position of each of the reflection speaker 24 and the reflection speaker 151 can be increased.

### Example 5 of Reflection Speaker

Meanwhile, in a case of using the single reflection speaker 24 for reproduction of content, it is considered to install the reflection speaker 24 on a ceiling inside a room at a position on a center axis of the display 61. However, there is room for improvement concerning such installability.

Specifically, for example, the reflection speaker 24 interferes with other devices such as a projector and lighting, that is, the installation position of the reflection speaker 24 is limited by installation of other devices in some cases. Moreover, when the reflection speaker 24 is installed on the center axis of the display 61, the reflection speaker 24 easily enters a visual field of the user (listener).

Furthermore, in a case of using a horn tweeter as the reflection speaker 24, directivity of the horn tweeter is defined by a horn shape. Accordingly, it is difficult for the horn tweeter to handle various sizes of the display 61 if one type of horn tweeter is used.

The present technology therefore uses two horn tweeters for reproduction of content and arranges these two horn tweeters at appropriate positions to improve (enhance) installability and handle various sizes of the display 61.

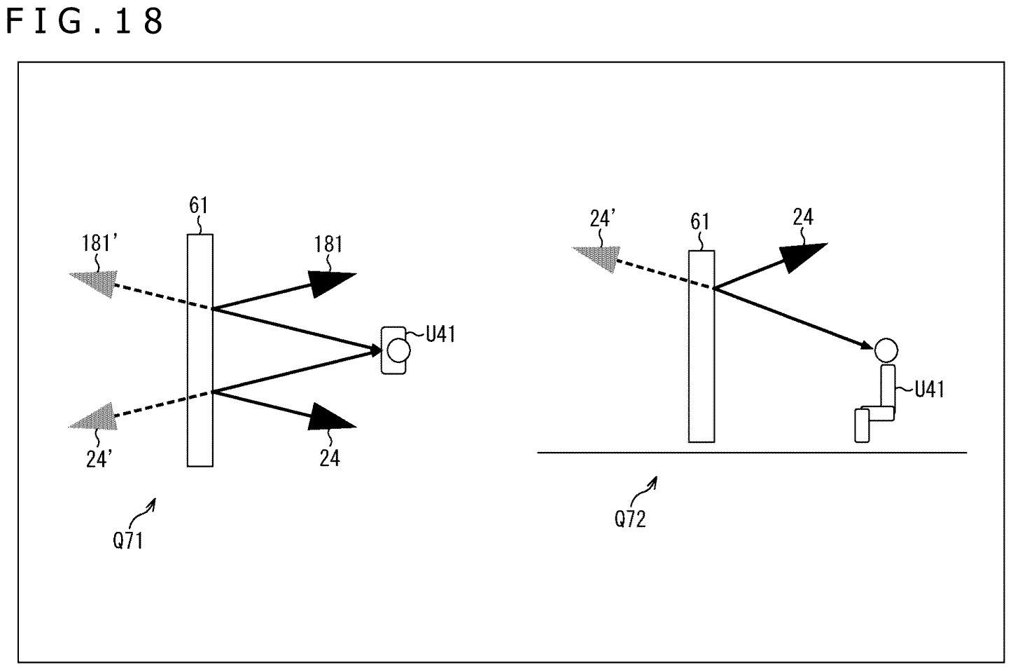

Specifically, as depicted in FIG. 18, for example, two reflection speakers including the reflection speaker 24 and a reflection speaker 181 are provided on the sound reproducing apparatus 11. The reflection speaker 24 and the reflection speaker 181 are symmetrically disposed with respect to the center axis of the display 61.

The center axis of the display 61 herein is a straight line passing through the center of the display screen of the display 61 and being perpendicular to the display screen.

In this example, the reflection speaker 24 and the reflection speaker 181 are of the same type, i.e., horn tweeters having the same horn shape and the same reproduction band. Moreover, the reflection speaker 181 may output sounds in accordance with high-band signals supplied from the HPF 23 similarly to the reflection speaker 24, or components of a gain adjustment unit to an HPF similar to those of the gain adjustment unit 21 to the HPF 23 may be provided in a stage before the reflection speaker 181.

In FIG. 18, a part indicated by an arrow Q71 is a diagram depicting a room interior which includes the display 61, the reflection speaker 24, and the reflection speaker 181 as viewed from above, while a part indicated by an arrow Q72 is a diagram depicting this room interior as viewed from a side.

Moreover, a reflection speaker 24′ and a reflection speaker 181′ represent mirror images of the reflection speaker 24 and the reflection speaker 181.

In this example, the reflection speaker 24 is disposed on a diagonally upper left part as viewed from a user U41 corresponding to a listener, while the reflection speaker 181 is disposed on a diagonally upper right part as viewed from the user U41. Accordingly, each of the reflection speaker 24 and the reflection speaker 181 is disposed at a position different from a position on the center axis of the display 61 as viewed from above. In addition, the reflection speaker 24 and the reflection speaker 181 are disposed at the same height.

During reproduction of content, sounds output from the reflection speaker 24 are reflected on the display screen of the display 61 and propagate in a direction toward the user U41. Similarly, sounds output from the reflection speaker 181 are reflected on the display screen of the display 61 and propagate in a direction toward the user U41.

Particularly in this example, the sounds from the reflection speaker 24 and the sounds from the reflection speaker 181 reflect on regions different from each other on the display screen of the display 61 and propagate toward the same position of the user U41.

In a case where the reflection speaker 24 and the reflection speaker 181 that are two horn tweeters are used as described above, sound fields formed by sounds output from the reflection speaker 24 and the reflection speaker 181 are predictable by using a simple model.

Accordingly, appropriate arrangement positions of the reflection speaker 24 and the reflection speaker 181 and irradiation angles of the sounds from these reflection speakers to the display 61 are derivable on the basis of a prediction result of the sound fields. In such a manner, the reflection speaker 24 and the reflection speaker 181 can be disposed in optimum positions and directions (angles). Accordingly, a service area suited for the size of the display screen of the display 61 can be formed.

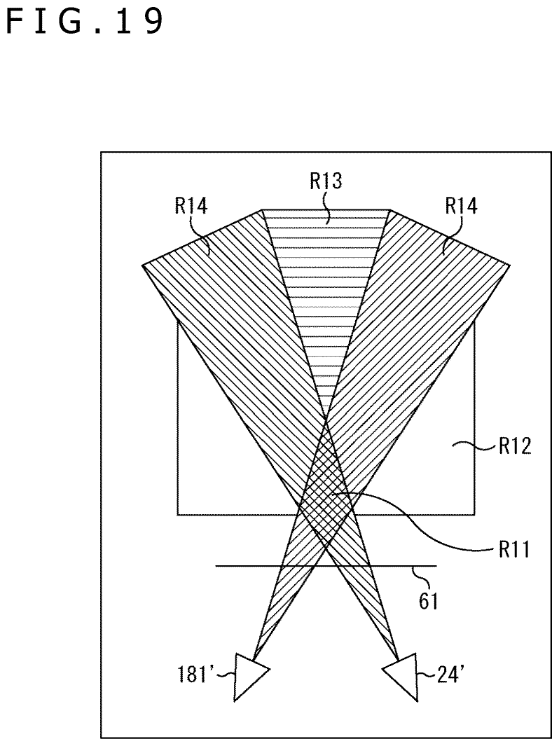

Specifically, in the arrangement depicted in FIG. 18, for example, a region where sounds of content are reproduced with high sound pressure can be formed in front of the display 61 as depicted in FIG. 19. Note that parts in FIG. 19 corresponding parts in FIG. 18 are given identical reference signs, and description of these parts will be omitted where appropriate.

In a region R11 in front of the display 61, sufficiently high sound pressure is securable by constructive interference by the sounds from the reflection speaker 24 and the sounds from the reflection speaker 181. Accordingly, this region R11 is available as a service area (listenable region).

In addition, for example, a region R12 is a region which is located outside irradiation axes of the reflection speaker 24 and the reflection speaker 181 and where sounds from these reflection speakers do not overlap with each other. In the region R12, less interference is caused by the sounds from the two reflection speakers, and therefore an effect of interference (phenomenon of constructive or destructive interference by both sound waves) as caused in the region R11 is smaller. In this case, sounds corresponding to high-band components of content have sound pressure attenuated and close to sound pressure corresponding to directivity of the single reflection speaker (horn tweeter). Accordingly, the region R12 is not available as a service area.

Moreover, for example, a region R14 is a region which is located on the irradiation axes of the reflection speaker 24 and the reflection speaker 181 and where sounds from these reflection speakers do not overlap with each other. In the region R14, less interference is caused by sounds from the two reflection speakers, and an effect of constructive interference as caused in the region R11 is smaller. However, sound pressure in the region R14 is high and close to sound pressure on the axis of the single reflection speaker (horn tweeter). Accordingly, the region R14 is available as a service area.

Furthermore, a region R13 located behind the region R11 is a region which is located inside the irradiation axes of the reflection speaker 24 and the reflection speaker 181 and where sounds from these reflection speakers do not overlap with each other. In the region R13, destructive interference of the sounds from the reflection speaker 24 and the sounds from the reflection speaker 181 is intensively exhibited, and therefore sound pressure lowers. In this case, the region R13 becomes a dead zone where sufficient sound pressure is not securable. Accordingly, the region R13 thus formed is not available as a service area.

By arranging the reflection speaker 24 and the reflection speaker 181 in appropriate positions and directions as in the example depicted in FIG. 18, lowering of sound pressure at positions on the center axis of the display 61 and close to the display 61 can be reduced, and the effect of destructive interference can be decreased to a minimum. In such a manner, a sufficiently wide service area can be formed at an appropriate position. In other words, the service area can be widened.

Moreover, the reflection speaker 24 and the reflection speaker 181 are not required to be disposed on the center axis of the display 61 in this example. Accordingly, not only installability can be improved, but also various sizes of the display 61 can be handled by one type of horn tweeter.

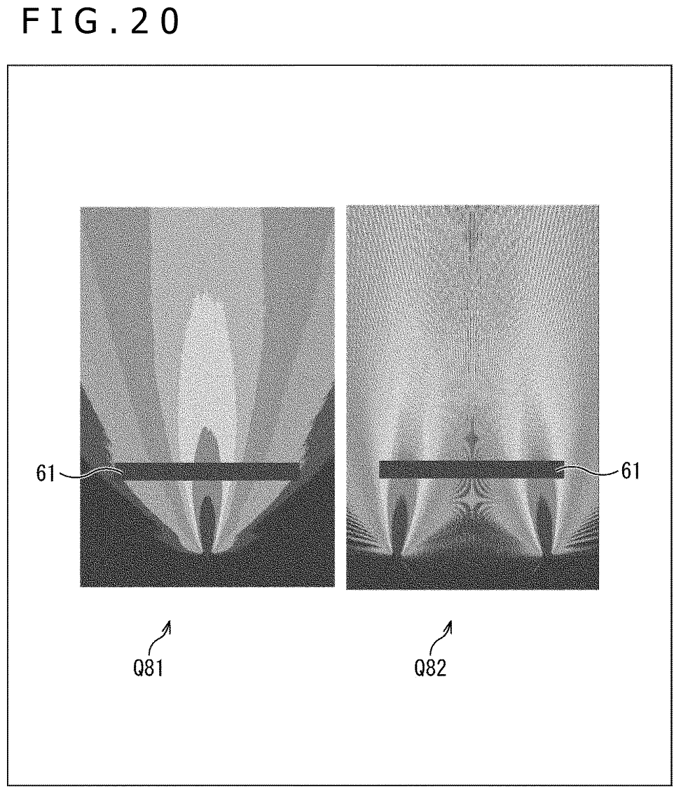

FIG. 20 herein presents a sound simulation result obtained when sounds are output from the reflection speaker 24 and the reflection speaker 181 that are horn tweeters in the arrangement depicted in FIG. 18. Note that each of a vertical direction and a horizontal direction in FIG. 20 represents a direction within a space as viewed from above and that shading in the figure represents sound pressure. Moreover, in this example, mirror image positions of the reflection speaker 24 and the reflection speaker 181 correspond to sound emission positions.

A part indicated by an arrow Q81 in FIG. 20 depicts sound pressure at each position produced when sounds at kHz are output from one horn tweeter disposed on the center axis of the display 61. On the other hand, a part indicated by an arrow Q82 depicts sound pressure at each position produced when sounds at 10 kHz are output from two horn tweeters disposed as depicted in FIG. 18.

As apparent from comparison between the example indicated by the arrow Q81 and the example indicated by the arrow Q82, the region exhibiting high sound pressure is wider in the example of using the two horn tweeters, and therefore a service area can be more widened in this example.

### Configuration Example of Computer

Incidentally, a series of processes described above can be executed either by hardware or by software. In a case where the series of processes are executed by software, a program constituting the software is installed in a computer. Examples of the computer herein include a computer incorporated in dedicated hardware, and a computer capable of executing various functions under various programs installed in the computer, such as a general-purpose personal computer.

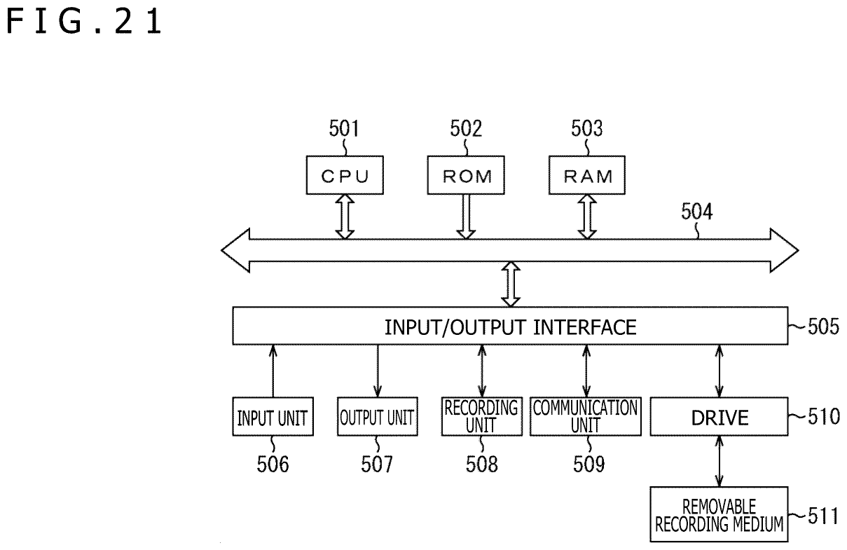

FIG. 21 is a block diagram depicting a configuration example of hardware of a computer which executes the series of processes described above under a program.

In the computer, a CPU (Central Processing Unit) 501, a ROM (Read Only Memory) 502, and a RAM (Random Access Memory) 503 are connected to one another via a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and others. The output unit 507 includes a display, a speaker, and others. The recording unit 508 includes a hard disk, a non-volatile memory, and others. The communication unit 509 includes a network interface and others. The drive 510 drives a removable recording medium 511 such as a magnetic disk, an optical disk, a magneto-optical disk, and a semiconductor memory.

According to the computer configured as described above, the CPU 501 loads a program recorded in the recording unit 508 into the RAM 503 via the input/output interface 505 and the bus 504, and executes the loaded program to perform the series of processes described above, for example.

The program executed by the computer (CPU 501) can be recorded in the removable recording medium 511 such as a package medium and can be provided in this form, for example. Alternatively, the program can be provided via a wired or wireless transfer medium, such as a local area network, the Internet, and digital satellite broadcasting.

In the computer, the program can be installed in the recording unit 508 via the input/output interface 505 from the removable recording medium 511 attached to the drive 510. Alternatively, the program can be received by the communication unit 509 via a wired or wireless transfer medium and can be installed in the recording unit 508. In addition, the program can be installed in the ROM 502 or the recording unit 508 beforehand.

Note that the program executed by the computer may be a program where the processes are performed in time series in an order described in the present description or may be a program where the processes are performed in parallel or at necessary timing such as an occasion when a call is made.

In addition, embodiments of the present technology are not limited to the embodiment described above, but can be modified in various manners without departing from the scope of the subject matters of the present technology.

For example, the present technology can have a configuration of cloud computing where one function is shared and processed by a plurality of devices in cooperation with each other via a network.

Moreover, the respective steps described in the above flowcharts may be executed by one device or may be shared and executed by a plurality of devices.

Furthermore, in a case where a plurality of processes are included in one step, the plurality of processes included in the one step can be executed by one device or can be shared and executed by a plurality of devices.

Note that the present technology can have the following configurations.

(1)

A sound reproducing apparatus including:
a reflection speaker that is able to perform directivity control and outputs a sound toward a predetermined surface on a basis of a high-band signal of a sound signal; and
a plurality of low-band speakers that is disposed near the predetermined surface and each outputs a sound on a basis of a low-band signal of the sound signal.
   (2)

The sound reproducing apparatus according to (1), further including:
a delay unit that performs a delay process for the sound signal or the low-band signal such that a sound output from the reflection speaker and reflected on the predetermined surface reaches a listener earlier than a sound output from each of the low-band speakers.
   (3)

The sound reproducing apparatus according to (1) or (2), in which each of the low-band speakers outputs, on the basis of the low-band signal, a sound that propagates by a spread degree substantially identical to a spread degree of a sound output from the reflection speaker and reflected on the predetermined surface.

(4)

The sound reproducing apparatus according to any one of (1) to (3), in which the reflection speaker is any one of an array tweeter, a horn tweeter, a beam tweeter, and a flat speaker.

(5)

The sound reproducing apparatus according to any one of (1) to (4), in which a plurality of the reflection speakers is provided.

(6)

The sound reproducing apparatus according to (5), in which the plurality of reflection speakers each outputs a sound in a different frequency band.

(7)

The sound reproducing apparatus according to (5) or (6), in which the plurality of reflection speakers each has a different reproduction band.

(8)

The sound reproducing apparatus according to (5), in which the plurality of reflection speakers each outputs a sound toward a different region in the predetermined surface.

(9)

The sound reproducing apparatus according to any one of (1) to (8), in which the reflection speaker changes a reflection position of a sound based on the high-band signal in the predetermined surface.

(10)

The sound reproducing apparatus according to any one of (1) to (9), in which the reflection speaker converges an output sound at a position that is closer to the reflection speaker than the predetermined surface, and then causes the sound to reflect on the predetermined surface.

(11)

The sound reproducing apparatus according to any one of (1) to (10), in which each of the low-band speakers is an array speaker or a speaker constituting a point sound source.

(12)

The sound reproducing apparatus according to any one of (1) to (11), in which each of the plurality of low-band speakers localizes a sound image of a sound based on the low-band signal at a position within the predetermined surface by panning.

(13)

The sound reproducing apparatus according to any one of (1) to (12), further including:
a high-band filter unit that generates the high-band signal on a basis of the sound signal; and
a low-band filter unit that generates the low-band signal on the basis of the sound signal.
   (14)

The sound reproducing apparatus according to (5), in which each of the plurality of reflection speakers is disposed at a position different from a position on a center axis of the predetermined surface.

(15)

A sound reproducing method for a sound reproducing apparatus that includes a reflection speaker that is able to perform directivity control, and a plurality of low-band speakers disposed near a predetermined surface, the sound reproducing method including:
outputting a sound toward the predetermined surface on a basis of a high-band signal of a sound signal by using the reflection speaker; and
outputting a sound on a basis of a low-band signal of the sound signal by using the plurality of low-band speakers.

### REFERENCE SIGNS LIST

11: Sound reproducing apparatus
23: HPF
24: Reflection speaker
25: Delay unit
28-1, 28-2, 28: LPF
29-1, 29-2, 29: Delay unit
30-1 to 30-4, 30: Low-band speaker
151: Reflection speaker
156: BPF

1. A sound reproducing apparatus comprising:
a reflection speaker that is able to perform directivity control and outputs a sound toward a predetermined surface on a basis of a high-band signal of a sound signal; and
a plurality of low-band speakers that is disposed near the predetermined surface and each outputs a sound on a basis of a low-band signal of the sound signal.

2. The sound reproducing apparatus according to claim 1, further comprising:
a delay unit that performs a delay process for the sound signal or the low-band signal such that a sound output from the reflection speaker and reflected on the predetermined surface reaches a listener earlier than a sound output from each of the low-band speakers.

3. The sound reproducing apparatus according to claim 1, wherein each of the low-band speakers outputs, on a basis of the low-band signal, a sound that propagates by a spread degree substantially identical to a spread degree of a sound output from the reflection speaker and reflected on the predetermined surface.

4. The sound reproducing apparatus according to claim 1, wherein the reflection speaker is any one of an array tweeter, a horn tweeter, a beam tweeter, and a flat speaker.

5. The sound reproducing apparatus according to claim 1, wherein a plurality of the reflection speakers is provided.

6. The sound reproducing apparatus according to claim wherein the plurality of reflection speakers each outputs a sound in a different frequency band.

7. The sound reproducing apparatus according to claim wherein the plurality of reflection speakers each has a different reproduction band.

8. The sound reproducing apparatus according to claim wherein the plurality of reflection speakers each outputs a sound toward a different region in the predetermined surface.

9. The sound reproducing apparatus according to claim 1, wherein the reflection speaker changes a reflection position of a sound based on the high-band signal in the predetermined surface.

10. The sound reproducing apparatus according to claim 1, wherein the reflection speaker converges an output sound at a position that is closer to the reflection speaker than the predetermined surface, and then causes the sound to reflect on the predetermined surface.

11. The sound reproducing apparatus according to claim 1, wherein each of the low-band speakers is an array speaker or a speaker constituting a point sound source.

12. The sound reproducing apparatus according to claim 1, wherein each of the plurality of low-band speakers localizes a sound image of a sound based on the low-band signal at a position within the predetermined surface by panning.

13. The sound reproducing apparatus according to claim 1, further comprising:
a high-band filter unit that generates the high-band signal on a basis of the sound signal; and
a low-band filter unit that generates the low-band signal on the basis of the sound signal.

14. The sound reproducing apparatus according to claim 5, wherein each of the plurality of reflection speakers is disposed at a position different from a position on a center axis of the predetermined surface.

15. A sound reproducing method for a sound reproducing apparatus that includes a reflection speaker that is able to perform directivity control, and a plurality of low-band speakers disposed near a predetermined surface, the sound reproducing method comprising:
outputting a sound toward the predetermined surface on a basis of a high-band signal of a sound signal by using the reflection speaker; and
outputting a sound on a basis of a low-band signal of the sound signal by using the plurality of low-band speakers.
